(19) United States
(12) Patent Application Publication
(10) Pub. No.: US 2026/0337862 A1
(43) Pub. Date: Oct. 29, 2026

(54) GARMENT PROCESSING DEVICE AND METHOD FOR CONTROLLING SAME

(71) Applicant: LG Electronics Inc., Seoul (KR)

(72) Inventors: Sunku KWON, Seoul (KR); Hyeongyu CHOI, Seoul (KR)

(21) Appl. No.: 19/119,597

(22) PCT Filed: Nov. 13, 2023
(86) PCT No.: PCT/KR2023/018138

§ 371 Date: Apr. 9, 2025

(30) Foreign Application Priority Data
Nov. 11, 2022 (KR) 10-2022-0150880

(51) Int. Cl. D06F 58/10; D06F 18/00; D06F 19/00; D06F 34/28; D06F 39/40; D06F 58/20; D06F 58/32; D06F 103/04; G01G 19/14; G01G 19/52

(52) U.S. Cl. CPC D06F 58/10; D06F 18/00; D06F 19/00; D06F 34/28; D06F 39/40; D06F 58/203; D06F 58/32; G01G 19/14; G01G 19/52; D06F 2103/04

(57) ABSTRACT

The present invention relates to a garment processing device capable of detecting at least one of the weight and length of a hung garment while driving a moving hanger capable of swinging the garment.

### CROSS-REFERENCE TO RELATED APPLICATIONS

This application is a National Stage application under 35 U.S.C. § 371 of International Application No. PCT/KR2023/018138, filed on Nov. 13, 2023, which claims the benefit of Korean Application No. 10-2022-0150880, filed on Nov. 11, 2022. The disclosures of the prior applications are incorporated by reference in their entirety.

### TECHNICAL FIELD

The present disclosure relates to a clothing treating apparatus and a method for controlling the same. More specifically, the present disclosure relates to a clothing treating apparatus and a method for controlling the same that may perform a refresh cycle such as sterilization, wrinkle removal, deodorization, drying, and the like of clothing by supplying steam and hot air to the clothing.

### BACKGROUND

A laundry treating apparatus refers to an apparatus that may wash and dry laundry and may remove wrinkles from the laundry at home and in a laundry shop. The apparatuses categorized as the laundry treating apparatus include a washing machine that washes the laundry, a dryer that dries the laundry, a washer/dryer that has both the washing function and the drying function, a laundry manager that refreshes the laundry, a steamer that removes wrinkles from the laundry, and the like.

In some cases, a laundry treating apparatus may refer to a laundry manager that allows the laundry to be kept pleasant and clean without having to soak the laundry in water and wash the same with detergent has appeared.

In some cases, a laundry treating apparatus may perform a refresh cycle by supplying one of high-temperature air (hot air) and steam to the laundry to deodorize the laundry, dry the laundry, and remove the wrinkles from the laundry has appeared.

In some cases, a laundry treating apparatus may accommodate the laundry therein by hanging the same from an upper end. For instance, the laundry treating apparatus may place the laundry in a height direction, and thus may also hang a plurality of laundry items along a width direction.

In some examples, the laundry treating apparatus may include a component (hereinafter, a moving hanger) that hangs the laundry inside thereof in a movable manner. For instance, the laundry treating apparatus may oscillate the laundry with the moving hanger when supplying hot air and steam to the laundry, thereby removing dust and foreign substances from the laundry.

In some cases, where the moving hanger is constructed to hang the laundry at an upper end of an accommodating space of the laundry treating apparatus, a degree and a form of oscillating of the laundry may vary depending on an operating frequency and an operating speed of the moving hanger.

The laundry treating apparatus may have various schemes to operate the moving hanger to oscillate the laundry in an optimal form at each time point to increase the refreshing effect.

FIG. 1 shows an example of oscillating the laundry in the laundry treating apparatus in related art.

In some cases, the more the laundry oscillates, the faster the foreign substances attached to the laundry or moisture contained in the laundry may be removed, so that it may be desirable for the moving hanger to operate at a maximum output.

Referring to a left diagram of (b) in FIG. 1, when the moving hanger moves too quickly, an excitation force generated from the moving hanger may be transmitted only to the upper end of the laundry, and a lower portion of the laundry may not be able to follow the movement of the moving hanger and may not vibrate with a sufficient amplitude.

Therefore, oscillating of the lower portion of the laundry may be slight, and there is a risk that fabric may be stretched or damaged because of a great displacement difference between the upper and lower portions of the laundry.

Referring to a right diagram of (b) in FIG. 1, it may be desirable for the moving hanger to operate at an optimal speed for the vibration generated from the moving hanger to be evenly transmitted from the upper portion to the lower portion of the laundry.

The laundry accommodated in the laundry treating apparatus may be the heaviest at the beginning because of supply of water or steam. The heavy laundry may not be easily oscillated by the moving hanger because of a great inertial force.

In some cases, as hot air is supplied and moisture evaporates from the laundry, the laundry may gradually become lighter. Because the inertial force of the laundry that has become lighter also decreases proportionally, the laundry may be relatively easily oscillated by the moving hanger.

Therefore, it may be desirable to oscillate the moving hanger based on the change in the inertial force of the laundry.

Referring to (a) in FIG. 1, the laundry treating apparatus may initially operate the moving hanger at a maximum speed V1-1 when the laundry is estimated to be the heaviest, and may operate the moving hanger by reducing the operating speed of the moving hanger in a stepwise manner considering that the laundry becomes lighter as moisture is dried by the hot air or moisture is removed by the vibration resulted from the moving hanger (V1-2,3 and V2).

In some cases, an oscillating force may be evenly transmitted to an entirety of the laundry while also preventing damage to the laundry, rather than unconditionally operating the moving hanger at a constant speed.

In some cases, the laundry treating apparatus may not operate the moving hanger based on the weight, a length, a type, a material, and the like of the laundry. In other words, the laundry treating apparatus may not directly sense the weight, the length, the material, and the like of the laundry, and therefore may not control the operating speed of the moving hanger based on a condition of the laundry, and adopts a moving hanger operating scheme standardized using a simple algorithm.

In some cases, the laundry treating apparatus may not operate the moving hanger based on the condition of the laundry, even though a form of movement of the laundry by the moving hanger differs depending on the weight, the length, the material, and the like of the laundry.

FIG. 2 shows a method for controlling an example of a laundry treating apparatus equipped with a moving hanger in related art.

The laundry treating apparatus equipped with the moving hanger may supply steam and hot air to the hung laundry to refresh the laundry.

Specifically, the laundry treating apparatus may operate in a preheating step C1 of preheating a steam generator, a steam step C2 of supplying steam from the steam generator, a waiting step C3 of stopping the supply of steam such that the supplied steam is introduced into the laundry, a cooling step C4 of lowering a surface temperature of the laundry and lowering a humidity of the accommodating space, and a drying step C5 of supplying hot air to the laundry by driving a heater or a compressor to dry the laundry.

In some cases, the laundry treating apparatus is set such that the moving hanger may not operate until the steam step C2 unless the laundry is washed by injecting water into the accommodating space.

This is because when the laundry is deviated from the moving hanger while the moving hanger is operating, there is a concern that the laundry may be damaged as the laundry blocks a steam supply port.

As a result, the laundry treating apparatus may be blocked from obtaining laundry information by operating the moving hanger not only before supplying hot air but also before supplying steam.

In some cases, the laundry treating apparatus may not adjust a supply scheme and a spray amount of steam appropriate for the condition of the laundry and may not adjust a supply amount and a supply time of the hot air, where the laundry treating apparatus may not directly sense the weight, the length, and the material of the laundry.

In some cases, where the moving hanger is constructed to move in an upper portion of the laundry accommodating space of the laundry treating apparatus, it may be difficult to install a separate load sensor or the like.

In some cases, where the laundry treating apparatus is configured to sense the weight of the laundry via an operating load of the moving hanger, it may not accurately sense the weight of the laundry because a change in a diffraction pattern of the laundry depending on the speed of the moving hanger or varying of a vibration force whenever a standing wave or the like occurs may not be reflected.

In some cases, the laundry treating apparatus may not refresh the laundry by considering the condition of the hung laundry because it may rely on a user's input for the information on the length and the material of the laundry.

### SUMMARY

The present disclosure describes a clothing treating apparatus that may sense a weight of hung clothing.

The present disclosure describes a clothing treating apparatus that may sense a length of hung clothing.

The present disclosure describes a clothing treating apparatus that may calculate at least one of a weight and a length of hung clothing via a moving hanger that oscillates the clothing.

The present disclosure describes a clothing treating apparatus that may optimally operate a moving hanger based on at least one of sensed weight and length of clothing.

The present disclosure describes a clothing treating apparatus that may optimally implement a scheme of supplying steam and hot air based on at least one of sensed weight and length of clothing.

The present disclosure describes a clothing treating apparatus that may sense at least one of a linear density, a degree of hydrophilicity, a material, and a type of hung clothing.

The present disclosure describes a clothing treating apparatus that may vary an operating speed, and steam spray and hot air supply schemes of a moving hanger depending on one or more of a linear density, a degree of hydrophilicity, a material, and a type of hung clothing.

The present disclosure may sense a weight of clothing during a process of operating a moving hanger.

The clothing may be curved or bend based on a movement of the moving hanger. Therefore, vibration characteristics of the clothing vary depending on a speed of the moving hanger.

When the clothing vibrates, a reaction force is applied to the moving hanger because of an inertia of a vibrating portion, which acts as a load torque of a moving hanger-driving motor.

In other words, characteristics of the load torque measured from the motor vary depending on variables (a speed, a clothing length, and the like) that determine the vibration characteristics of the clothing. Therefore, when only an amount of clothing is desired to be sensed, factors that affect the vibration characteristics except for a weight of the clothing may be excluded as many as possible.

A standing wave occurs on the clothing at a certain speed, and the clothing vibrates in a non-standing wave at other speeds. Because such vibration characteristics vary depending on the length of the clothing, such vibration characteristics resulted from the length may be excluded for the sensing of the amount of clothing.

Therefore, the clothing treating apparatus of the present disclosure operates the moving hanger at a low speed to prevent the diffraction or the bending of the clothing, thereby blocking reflection of a variable based on the length in the vibration characteristics.

The present disclosure describes a clothing treating apparatus in which a controller calculates the weight of the clothing while operating the moving hanger at a frequency lower than a fundamental frequency (period) allowing a waveform or vibration to start occurring on the clothing.

The controller may sense the fundamental frequency allowing the waveform or the vibration to start occurring on the clothing while operating the moving hanger.

The controller may sense the fundamental frequency while operating the moving hanger by increasing an operating frequency from a stationary state, and calculate the weight of the clothing while operating the moving hanger at the frequency equal to or lower than the fundamental frequency.

The controller may operate the moving hanger at a frequency higher than the fundamental frequency when supplying at least one of steam and hot air to the inner casing.

A maximum frequency for the controller to operate the moving hanger when supplying at least one of steam and hot air to the inner casing may vary depending on the weight of the clothing.

The maximum frequency to operate the moving hanger may be set lower as the weight of the clothing increases.

The controller may operate the machine room to supply steam or hot air to the clothing after sensing the weight of the clothing.

The controller may control the machine room such that a spray amount of steam is greater or a spray time of steam is greater when the clothing is heavy than when the clothing is light.

The machine room may be controlled such that a supply amount of hot air or a supply time of hot air is greater when the clothing is heavy than when the clothing is light.

The clothing treating apparatus may further include a display that is disposed on at least one of the cabinet and the door and externally displays the sensed weight of the clothing.

The display may display the weight of the clothing before steam or hot air is supplied to the accommodating space.

The display may display at least one of the weight and a length of the clothing when power is supplied and the door closes an opening.

The machine room may be equipped with a steam generator that supplies steam to the accommodating space and a compressor that pressurizes a refrigerant exchanging heat with air supplied to the accommodating space, and the display may display the weight of the clothing before the steam generator or the compressor is operated.

The controller may operate the moving hanger to sense the weight of the clothing and the resonant frequency allowing the clothing to vibrate in the standing wave.

The controller may sense the weight of the clothing while operating the moving hanger at a frequency lower than a fundamental frequency (period) allowing a waveform or vibration to start occurring on the clothing, and sense the resonant frequency while operating the moving hanger at a higher speed.

The controller may, when the weight of the clothing is sensed by operating the moving hanger at the frequency lower than the fundamental frequency, sense and identify the resonant frequency while changing an operating frequency of the moving hanger.

The controller may, when the weight of the clothing is sensed by operating the moving hanger at the frequency lower than the fundamental frequency, sense and identify the resonant frequency while increasing an operating frequency of the moving hanger in a stepwise manner.

The controller may determine an optimal frequency of operating the moving hanger based on the sensed weight of the clothing, and operate the moving hanger at a resonant frequency close to the optimal frequency in at least some periods during the course execution.

The controller may operate the moving hanger at a resonant frequency higher than the optimal frequency and at a resonant frequency lower than the optimal frequency in at least some periods during the course execution.

The controller may repeat operating the moving hanger at a resonant frequency higher than the optimal frequency for a certain time period and operating the moving hanger at a resonant frequency lower than the optimal frequency for a certain time period.

The controller may operate the moving hanger at the resonant frequency allowing the clothing to vibrate in the standing wave in at least some periods during the course execution, but operate the moving hanger at two or more resonant frequencies allowing the clothing to vibrate in standing waves.

The controller may operate the moving hanger at a first resonant frequency allowing the clothing to vibrate in a standing wave for a first time period, and operate the moving hanger at a second resonant frequency allowing the clothing to vibrate in a different standing wave for a second time period.

The controller may operate the moving hanger at the resonant frequency allowing the clothing to vibrate in the standing wave when vibration of a magnitude equal to or greater than a reference value occurs in the moving hanger.

A clothing treating apparatus of the present disclosure provides a control method including a sensing step of sensing a weight and a length of clothing hung in an accommodating space, and an operating step of supplying steam and hot air to the clothing to treat the clothing,

The sensing step may include operating the moving hanger, but blocking operation of at least one of the steam generator and the compressor.

An operating speed of the driver in the sensing step may be set lower than an operating speed of the driver in the operating step.

In the sensing step, a duration of the operating step may be set greater when the clothing is sensed as heavy than when the clothing is sensed as light.

In the operating step, an operating time of the steam generator may be set greater when the clothing is sensed as heavy in the sensing step than when the clothing is sensed as light.

In the operating step, an operating time of the compressor or an operating rpm of the compressor may be set greater when the clothing is sensed as heavy in the sensing step than when the clothing is sensed as light.

The clothing treating apparatus may accurately sense the weight of the hung clothing.

The clothing treating apparatus may accurately sense the length of the hung clothing.

The clothing treating apparatus may calculate one or more of the weight and the length of the hung clothing via the moving hanger that oscillates the clothing.

The clothing treating apparatus may optimally operate the moving hanger based on one or more of the sensed weight and length of the clothing.

The clothing treating apparatus may optimally implement the scheme of supplying steam and supplying hot air based on one or more of the sensed weight and length of the clothing.

The clothing treating apparatus may sense one or more of the linear density, the degree of hydrophilicity, the material, and the type of the hung clothing.

The clothing treating apparatus may vary the operating speed, and the steam spray and hot air supply schemes of the moving hanger based on one or more of the linear density, the degree of hydrophilicity, the material, and the type of the hung clothing.

### BRIEF DESCRIPTION OF THE DRAWINGS

FIG. 1 shows an example of clothing treating apparatus in related art.

FIG. 2 shows an example method for controlling a clothing treating apparatus in related art.

FIG. 3 shows an outer appearance of a clothing treating apparatus of the present disclosure.

FIG. 4 shows a structure of an example of a machine room of a clothing treating apparatus of the present disclosure.

FIG. 5 shows a structure of an example of a moving hanger of a clothing treating apparatus of the present disclosure.

FIG. 6 shows an example of an operation process of a moving hanger.

FIG. 7 shows an example structure of a moving hanger of a clothing treating apparatus of the present disclosure.

FIG. 8 is a perspective view showing an example of a moving hanger of a clothing treating apparatus of the present disclosure.

FIG. 9 shows a structure of an example of a moving hanger separated from an inner casing.

FIG. 10 is an exploded perspective view showing an example of a moving hanger.

FIG. 11 shows an operating state of an example of a moving hanger.

FIG. 12 shows an operation process of an example of a moving hanger.

FIG. 13 shows an example in which a moving hanger rotates clothing.

FIG. 14 shows an example control block diagram of a clothing treating apparatus of the present disclosure.

FIG. 15 shows an example in which a driver of a clothing treating apparatus of the present disclosure senses load information of clothing.

FIG. 16 shows an example state in which clothing vibrates when a moving hanger operates.

FIG. 17 shows an example state in which clothing vibrates in a standing wave when a moving hanger operates at a resonant frequency.

FIG. 18 shows an example of a control method of oscillating clothing while changing a resonant frequency.

FIG. 19 shows an example of a method for controlling a clothing treating apparatus of the present disclosure.

FIG. 20 shows an example of a method for controlling a clothing treating apparatus of the present disclosure.

FIG. 21 shows an example of a change in vibration characteristics when a length of clothing changes.

FIG. 22 shows an example of sensing a weight and a length of clothing of a clothing treating apparatus of the present disclosure.

FIG. 23 shows an example of a clothing treating apparatus of the present disclosure performing a course.

FIG. 24 shows an example of a clothing treating apparatus of the present disclosure performing a course.

FIG. 25 shows an example of a clothing treating apparatus of the present disclosure sensing a material and a moisture content of clothing.

FIG. 26 shows an example of a control method of a clothing treating apparatus of the present disclosure sensing a material and a moisture content of clothing.

FIG. 27 shows an example of a control method of a clothing treating apparatus of the present disclosure sensing a material and a moisture content of clothing.

FIG. 28 shows an example of a method for controlling a clothing treating apparatus of the present disclosure.

FIG. 29 shows an example of a clothing treating apparatus of the present disclosure displaying clothing information.

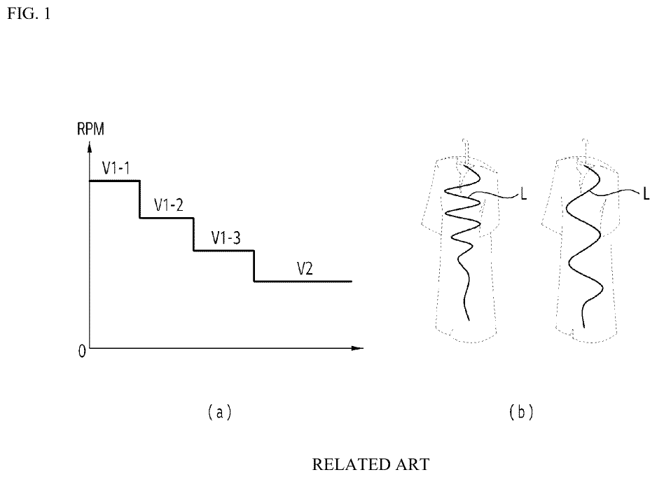

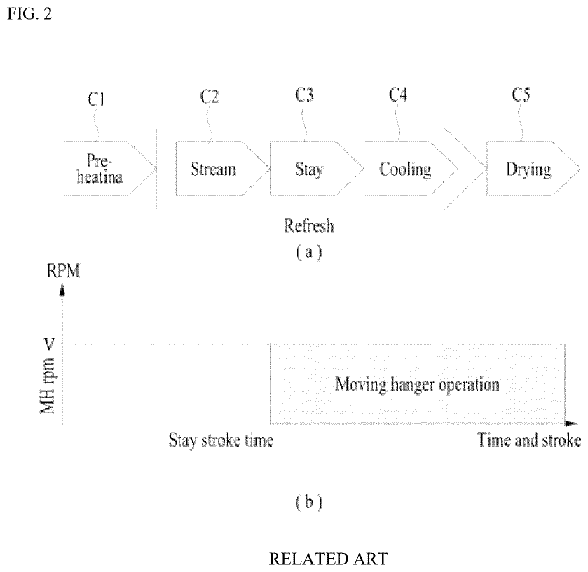

### DETAILED DESCRIPTION

Hereinafter, implementations disclosed herein will be described in detail with reference to the attached drawings. As used herein, the same or similar components are assigned with the same or similar reference numerals even in different implementations, and description thereof is replaced with the first description. The singular expression used herein includes the plural expression unless the context clearly indicates otherwise. In addition, when describing the implementations disclosed herein, when it is determined that a specific description of a related known technology may obscure the gist of the implementations disclosed herein, the detailed description thereof will be omitted. In addition, it should be noted that the attached drawings are only intended to facilitate easy understanding of the implementations disclosed herein, and the technical ideas disclosed herein should not be construed as being limited by the attached drawings.

In the present application, the terms “laundry,” “clothes,” “clothing,” and “garment” may be used interchangeably.

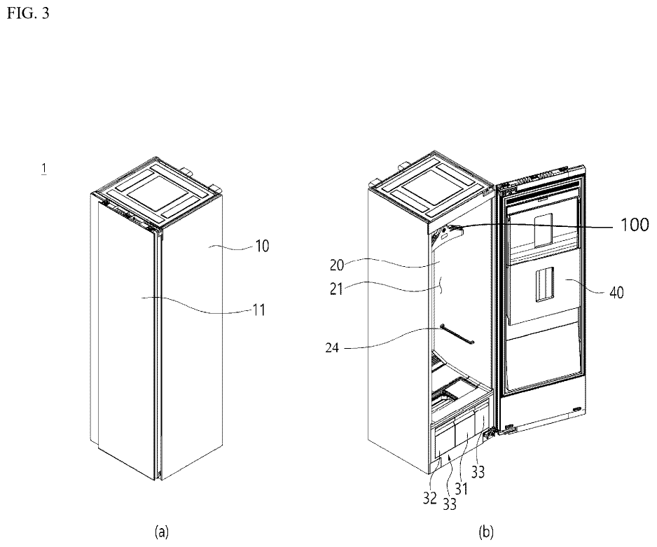

FIG. 3 shows an outer appearance of a clothing treating apparatus 1 of the present disclosure.

Referring to (a) in FIG. 3, the clothing treating apparatus of the present disclosure may include a cabinet 10 forming the outer appearance thereof, and a door 11 pivotably coupled to the cabinet 10.

The door 11 may have a height and a width the same as those of a front surface of the cabinet 10 and may form a front surface of the clothing treating apparatus 1.

The door 11 may include an input part that receives a command to operate the clothing treating apparatus, and may include a display that may display an operating state of the clothing treating apparatus visually or audibly to the outside.

Referring to (b) in FIG. 3, an inner casing 20 having an accommodating space 21 that accommodates clothing therein may be disposed inside the cabinet 10. The inner casing 20 may include an opening or space 21 through which the clothing enters and exits at the front, and the opening or space 21 may be shielded by the door 11.

The inner casing 20 may be made of a plastic resin-based material, and may be made of a reinforced plastic resin-based material that does not deform even when exposed to air at a temperature higher than a room temperature or heated air (hereinafter, hot air), steam, or moisture.

The inner casing 20 may have a height greater than a width. As a result, the clothing may be accommodated in the accommodating space 21 without being folded or crumpled.

The clothing treating apparatus 1 of the present disclosure may include a clothing hanger that may hang the clothing in the accommodating space 21 of the inner casing 20. The clothing hanger may be mounted on a moving hanger 100 that is seated in the inner casing 20 and hangs the clothing thereon.

The moving hanger 100 may be exposed to an inner top surface of the inner casing 20 such that the clothing hanger may be mounted thereon. The moving hanger 100 may be disposed on the top surface of the inner casing 20 so as to reciprocate to oscillate the clothing. A detailed structure of the moving hanger 100 will be described later.

When the clothing is hung on the moving hanger 100, the clothing may be hung in a state of being suspended in air inside the accommodating space 21 and stretched in a height direction. Accordingly, the clothing hung in the accommodating space 21 may be evenly exposed to hot air and steam, and wrinkles may be removed therefrom by its own weight.

The clothing treating apparatus of the present disclosure may further include a pressurizer 40 that is coupled to an inner surface of the door 11 to fix the clothing.

The pressurizer 40 may be pivotably coupled to an inner side of the door 11 and pressurize the clothing fixed to the inner surface of the door 11 toward the inner surface of the door 11.

The pressurizer 40 may create intended creases on both sides of the clothing.

The clothing treating apparatus of the present disclosure may further include a machine room 30 in which various apparatuses that may supply at least one of hot air and steam to the accommodating space 21 or purify or dehumidify outside air of the cabinet 10 are installed.

The machine room 30 may be disposed separately or partitioned from the inner casing 20, but may be in communication with the inner casing 20.

The machine room 30 may be disposed under the inner casing 20. Accordingly, when hot air and steam having low specific gravities are supplied to the inner casing 20, hot air and steam may be naturally supplied to the clothing.

The machine room 30 may include a circulation duct that circulates air inside the inner casing 20, and a plurality of heat exchangers that are disposed on the circulation duct to cool and condense the air and heat the air.

The machine room 30 may be equipped with a heat pump system that includes a compressor that is connected to the plurality of heat exchangers and is able to compress a refrigerant that cools or heats the air.

The machine room 30 may also be equipped with a steam supply 50 that may supply steam into the inner casing 20. The steam supply 50 may heat water to generate steam. The clothing accommodated inside the inner casing may be exposed to hot air generated by the heat pump system and steam generated by the steam supply 50 to perform deodorization, sterilization, wrinkle removal, and drying.

A water tank 31 that supplies water for generating the steam, and a drain tank 32 that collects condensed water from the circulation duct may be included in a front portion of the machine room 30.

The water tank 31 and the drain tank 32 may be detachably disposed in the front portion of the machine room 30. Accordingly, even when the clothing treating apparatus of the present disclosure is not disposed near a water source or a drain hole, a user may detach and transport the water tank 31 and the drain tank 32.

The water tank 31 and the drain tank 32 may be arranged in parallel with each other along a width direction of the machine room 30.

In addition, the machine room 30 may further include a drawer 33 that accommodates therein items or the like for managing the clothing. The drawer 33 may be extendable from the machine room 30, and may have a space defined therein where the items such as an iron may be accommodated.

The clothing treating apparatus 1 of the present disclosure may include a mounting stand 24 on which a separate shelf may be seated inside the inner casing 20. The mounting stands 24 may protrude at the same vertical level on both side surfaces of the inner casing 20.

The mounting stand 24 may have a light-emitter installed to irradiate light into the inner casing 20. The light-emitter may be equipped so as to radiate light toward an inner side surface of the inner casing 20 to prevent glare.

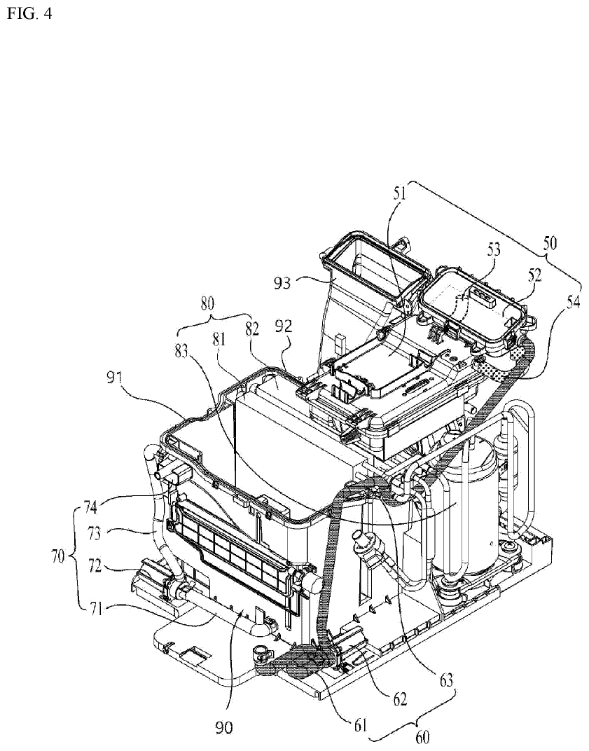

FIG. 4 shows an example of a structure of a machine room.

The machine room 30 may be disposed under the inner casing 20 to provide a space where a heat pump system 80 and the steam supply 50 are installed, and may include a duct 90 that provides a flow channel for circulating air inside the inner casing 20.

The duct 90 may form a circulation flow channel that is in communication with each of an inlet and an outlet of the inner casing 20, and may define a space in which air inside the inner casing 20 flows. A blower fan may be disposed inside the duct 90. The blower fan may generate a pressure difference to suck and discharge air inside the accommodating space 21.

The duct may be formed in a rectangular shape with a partially open upper portion, and a separate cover may be coupled at the upper portion to complete the internal flow channel. The duct 90 may include an inflow duct 91 that is in communication with the inner casing 20 and allows air to be introduced thereinto, a discharge duct 92 that is spaced apart from the inflow duct 91, is in communication with the inner casing 20, and allows air to be discharged, and a flow duct 93 that connects the inflow duct 91 with the discharge duct 92 and forms a flow channel through which air flows.

The heat pump system 80 may include an evaporator 81 that is accommodated inside the duct 90 and cools the air, a condenser 82 that heats air that has passed through the evaporator 81 to generate hot air, and a compressor 83 that compresses and heats the refrigerant that has passed through the evaporator 81 and supplies the refrigerant to the condenser 82, and may further include an expansion valve that expands and cools the refrigerant that has passed through the condenser 82 and delivers the refrigerant to the evaporator 81.

The evaporator 81 and the condenser 82 may be accommodated in the flow duct 93, and the compressor 83 and the expansion valve may be disposed outside the duct 90.

The evaporator 81 and the condenser 82 may be arranged along a direction in which air flows. For example, the evaporator 81 may be disposed closer to the inflow duct 91 than the condenser 82, and the condenser 82 may be disposed closer to the discharge duct 92 than the evaporator 81.

The steam supply 50 may be disposed inside the duct 90.

The steam supply 50 may be disposed outside the duct 90 so as not to obstruct the flow of air flowing along the duct 90.

The steam supply 50 may include a steam generator 51 that receives and stores water and generates steam by heating water with a heater or the like inside, and a steam nozzle 52 that supplies steam generated by the steam generator 51 to the accommodating space 21.

The steam nozzle 52 may be in communication with the inner casing 20 and may be disposed adjacent to the discharge duct 92. The steam generator 51 may be supported by being seated on the duct 90 and may support the steam nozzle 52.

The steam supply 50 may further include a recovery pipe 54 that allows the steam nozzle 52 and the steam generator 51 to be in communication with each other.

The recovery pipe 54 may recover water that has not been discharged to the outside from the steam nozzle 52 and has condensed back to the steam generator 51. The steam nozzle 52 may be disposed upward of the steam generator 51, so that steam may be automatically supplied to the inner casing 20 by a density difference and water may be recovered to the steam generator 51 by gravity.

The steam nozzle 52 may not be a simple hose, but may be formed in a shape of a casing made of a plastic material or the like and capable of containing at least one of steam, air, and water inside.

The steam supply 50 may further include a steam pipe 53 connecting the steam generator 51 with the steam nozzle 52. Steam generated by the steam generator 51 may be supplied into the steam nozzle 52 along the steam pipe 53 and supplied into the inner casing 20.

The machine room 30 may further include a water supply 60 that may supply water for generating steam in the steam supply 50.

The water supply 60 may receive water from the water tank 31 seated in the front portion of the machine room 30 and supply water to the steam supply 50.

The water supply 60 may include a water supply pipe 61 that receives water from the water tank 31, a supply pipe 63 that supplies water from the water supply pipe 61 to the steam supply 50, and a water supply pump 62 that provides power to supply water from the water supply pipe 61 to the supply pipe 63.

The water tank 31 may be detachable from a front side of the duct 90, and the water supply pump 62 may be disposed outside the duct 90.

The supply pipe 63 may be in communication with the steam generator 51 and supply water to the steam generator 51.

Alternatively, the supply pipe 63 may be in communication with the steam nozzle 52 and supply water to the steam nozzle 52. That is, the water supply 60 may directly supply water to the steam nozzle 52 and indirectly supply water to the steam generator 51 via the recovery pipe 54. This allows a flow channel structure to be simplified.

The machine room 30 may further include a drainage 70 that collects water condensed in the evaporator 81 in the drain tank 32.

The drainage 70 may include a drain pipe 71 that is in communication with a bottom surface of the duct 90 and discharges water collected in a lower portion of the duct 90 to the outside of the duct 90, a drain pump 72 that supplies water discharged via the drain pipe 71 to the drain tank 32, and a drain pipe 73 that supplies water supplied to the drain pump 72 to the drain tank 32.

In one example, the drainage 70 may further include a recovery duct 74 that allows the duct 90 and the drain tank 32 to be in communication with each other to re-direct water in the drain tank 32 into the duct 90. As a result, even when the drain tank 32 is full, water collected in the drain tank 32 may be prevented from leaking to the outside.

The clothing treating apparatus of the present disclosure may supply hot air and steam to the inner casing 20 via the machine room 30 at an appropriate time when a clothing refresh cycle, which performs the sterilization, the deodorization, the wrinkle removal, the drying, and the like, is performed, and may condense moisture discharged from the inner casing 20 and collect moisture in the drain tank 32.

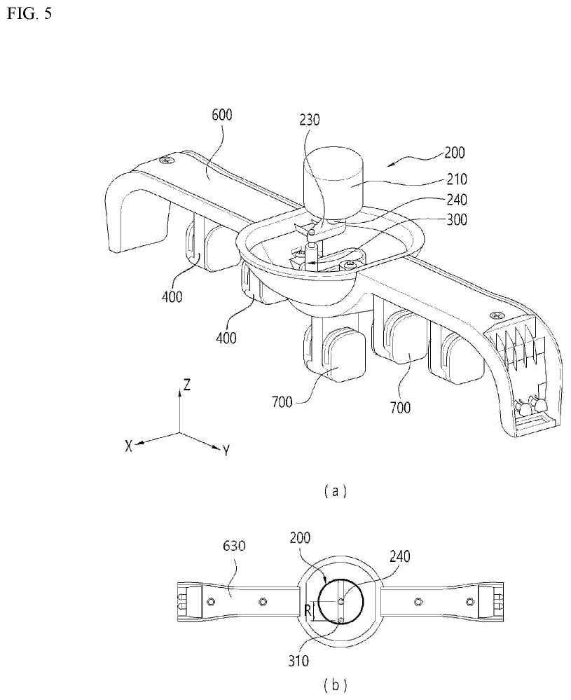

FIG. 5 shows an example of the moving hanger 100 of the clothing treating apparatus of the present disclosure.

Referring to (a) in FIG. 5, the moving hanger 100 may include a hanger 700 on which the clothing or the clothes hanger 900 is mounted, a plurality of power transmitters 400 that are coupled to the hanger 700 and support a load of the clothes, a connector 600 that connects the plurality of power transmitters 400 to each other, and a driver 200 that provides power to reciprocally move the connector 600 and the plurality of power transmitters 400.

The plurality of power transmitters 400 may be arranged to be spaced apart from each other along a direction in which the clothing items are arranged in the accommodating space 21.

The plurality of power transmitters 400 may be disposed along a height direction of the clothing treating apparatus, and the connector 600 may be seated on a top surface of the inner casing 20.

The connector 600 may be formed integrally with the plurality of power transmitters 400, and may be connected to the driver 200 located thereon.

The driver 200 and the connector 600 may be supported by a separate support frame and disposed on the inner casing 20.

The connector 600 may include a connecting bar 630 formed in a rod shape, and the connecting bar 630 may be connected to the driver 200 in a scotch yoke structure.

Therefore, when the driver 200 generates the rotating power, the connecting bar 630 may reciprocate along a longitudinal direction or the direction in which the power transmitters 400 are arranged so as to be spaced apart from each other.

The driver 200 may include a motor 210 that transmits the power to reciprocate the connecting bar 630, a power shaft 240 that rotates by the motor 210, a transmitter 230 that transmits the power of the power shaft 240, and a displacement generator 300 that is connected to the transmitter 230 and transforms the rotational motion of the power shaft 240 into a motion along a predetermined trajectory.

For example, the transmitter 230 may include a transmission rod 236 that has one end coupled to the power shaft 240 and the other end extending along a radial direction of a rotation shaft 220 to rotate together with the power shaft 240. The displacement generator 300 may include an eccentric shaft 310 that is coupled to the other end of the transmission rod 236 and coupled to the connecting bar 630. The eccentric shaft 310 may rotate along a trajectory longer than that of the power shaft 240.

Referring to (b) in FIG. 5, the connecting bar 630 may have a slit 631 into which the eccentric shaft 310 is inserted, and the slit 631 may be defined perpendicular to a moving direction of the connecting bar 630. For example, the slit 631 may be defined in a thickness direction of the connecting bar 630.

A length of the slit 631 may be at least twice a rotation radius R of the eccentric shaft 310, and a width of the slit 631 may be greater than a diameter of the eccentric shaft 310.

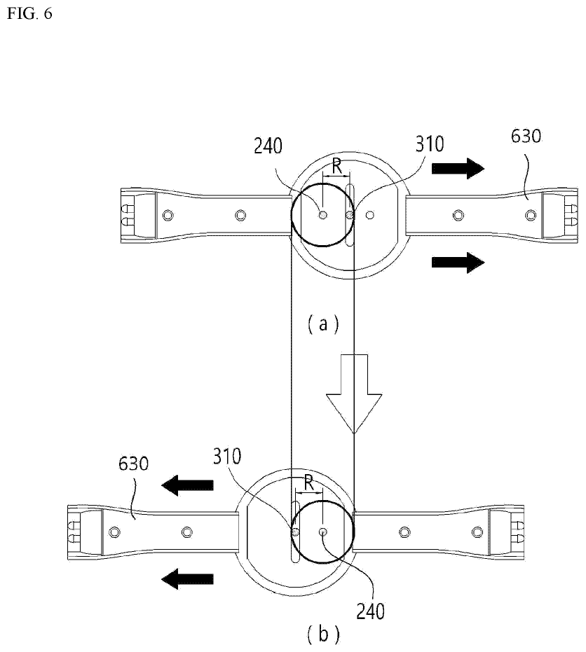

FIG. 6 shows an operational example of the moving hanger.

Referring to (a) in FIG. 6, the power shaft 240 has a fixed location, and the eccentric shaft 310 continuously rotates in one of a clockwise direction and a counterclockwise direction while drawing a trajectory along the rotation radius R based on the power shaft 240.

The eccentric shaft 310 may move to the right of the power shaft 240 while rotating around the power shaft 240. In such process, the slit 631 defined in the connecting bar 630 may receive a force to move to the right by the eccentric shaft 310, and the connecting bar 630 may move to the right.

Referring to (b) in FIG. 6, the eccentric shaft 310 may rotate more continuously in the same direction and move to the left of the power shaft 240. In such process, the slit 631 defined in the connecting bar 630 may receive a force to move to the left by the eccentric shaft 310, and the connecting bar 630 may move to the left.

When the eccentric shaft 310 rotates further, the eccentric shaft 310 may be repeatedly located at the locations in (a) and (b) in FIG. 6, and the connecting bar 630 may reciprocally move left and right.

As a result, the power transmitter 400 coupled to the connecting bar 630 may also reciprocally move left and right, and the hanger 700 coupled to the power transmitter 400 and the clothing hung on the hanger 700 may also oscillate.

When the eccentric shaft 310 rotates once, the connecting bar 630 may reciprocally move left and right once, and a moving direction thereof may change twice.

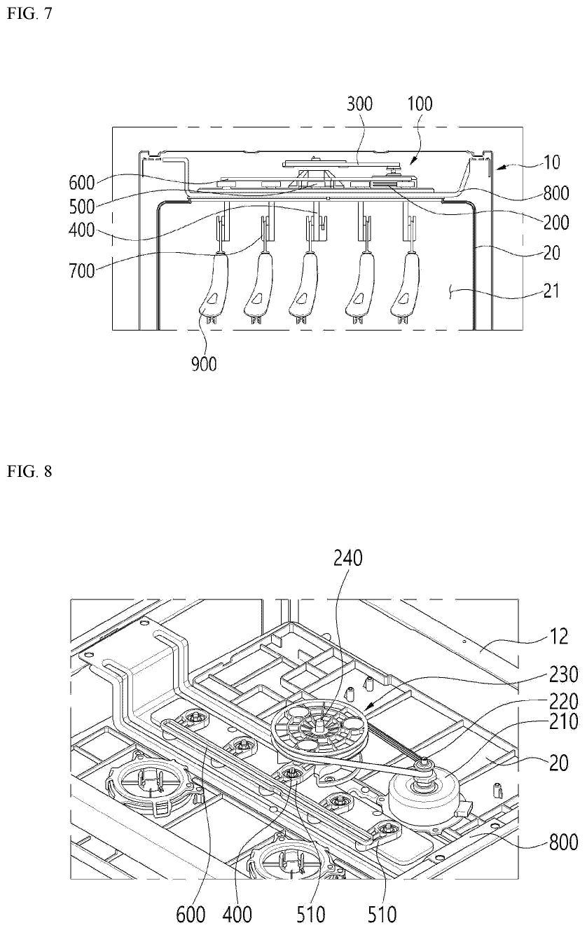

FIG. 7 shows another example of the moving hanger 100 of the clothing treating apparatus of the present disclosure.

In some implementations, the moving hanger 100 may also include the power transmitter 400 that is disposed on the inner casing 20 and oscillates the clothes hanger 900.

The hanger 700 on which the clothes hanger 900 may be seated or hung may be disposed on a lower portion of the power transmitter 400.

Accordingly, when the power transmitter 400 moves, the hanger 700 may move, and the clothes hanger 900 hung on the hanger 700 may oscillate, thereby oscillating the clothes.

The power transmitter 400 may include the plurality of power transmitters, and the hanger 700 coupled to the power transmitter 400 may also include a plurality of hangers. Accordingly, a large amount of clothing corresponding to the number of power transmitters 400 may be hung inside the inner casing 20 and refreshed.

The moving hanger 100 may further include the driver 200 that provides the power to move the power transmitter 400.

The driver 200 may be exposed into the inner casing 20 as long as it is able to transmit the power to the power transmitter 400. In some examples, where the driver 200 operates by receiving electric energy, the driver 200 may be covered to avoid exposure to steam or hot air.

Accordingly, the driver 200 may be disposed between the top surface of the inner casing 20 and the cabinet 10 to be blocked from being exposed to the accommodating space 21.

The power transmitter 400 may receive the power from the driver 200 by extending through the upper portion of the inner casing 20. The power transmitter 400 may extend downwards by extending through the upper portion of the inner casing 20, so that a lower end thereof may be exposed to the accommodating space 21.

The power transmitter 400 may be formed in a rod shape, a tube shape, a plate shape, or the like whose length is greater than a thickness.

In one example, the top surface of the inner casing 20 may support loads of the power transmitter 400 and the driver 200. In some examples, the clothing is hung and moves on the power transmitter 400, and the load of the driver 200 is also relatively great. Therefore, to stably install the moving hanger 100 on the top surface of the inner casing 20, the clothing treating apparatus 1 of the present disclosure may further include a support 800.

The support 800 may be disposed on the top surface of the inner casing 20, and may be supported by being coupled to the cabinet 10. The support 800 may be made of a metal material whose shape is difficult to change.

The power transmitter 400 and the driver 200 may be seated on the support 800 and be disposed on the top surface of the inner casing 20.

In one example, the driver 200 includes the motor that rotates the rotation shaft. The driver 200 may move the power transmitter 400 with the power that rotates the rotation shaft.

In some cases, it may be difficult to oscillate the power transmitter 400 with a sufficient displacement by simply rotating the rotation shaft in place.

Therefore, the moving hanger 100 may further include the displacement generator 300 that is coupled to the rotation shaft and generates the sufficient displacement to allow the power transmitter 400 to move.

The displacement generator 300 may connect the rotation shaft with the power transmitter 400 and transmit the power of the rotation shaft to the power transmitter 400.

The displacement generator 300 may include the eccentric shaft that rotates along the trajectory greater than the diameter of the rotation shaft by the rotation shaft. The eccentric shaft may generate displacement that causes the power transmitter 400 to reciprocally move within a predetermined range.

Therefore, when the driver 200 operates, the power generated by the rotation shaft may be transmitted to the power transmitter 400, so that the power transmitter may reciprocally move within the predetermined range.

The moving hanger 100 may oscillate the clothing by reciprocally rotating the power transmitter 400 instead of reciprocally moving the power transmitter 400 left and right.

Specifically, the moving hanger 100 may reciprocally rotate the power transmitter 400 within a predetermined angular range instead of reciprocally moving the same in a straight line.

Accordingly, the power transmitter 400 may reciprocally rotate left and right in place, and the clothing hung on the power transmitter 400 may also reciprocally rotate left and right, but not reciprocally move left and right.

As a result, even when the clothing rotates inside the inner casing 20 because of the power transmitter 400, a movement of a center of gravity inside the inner casing 20 may be restricted. Accordingly, even when the moving hanger 100 operates, vibration generated inside the inner casing 20 may be drastically reduced, and as a result, noise generation may also be decreased.

The moving hanger 100 may further include a power-to-rotation converter 500 that converts continuous rotational energy generated from the driver 200 or the displacement generator 300 into the reciprocating rotational motion of the power transmitter 400.

The power-to-rotation converter 500 may connect the displacement generator 300 with the power transmitter 400. The power-to-rotation converter 500 may connect the displacement generator 300 with the power transmitter 400 at a location above the inner casing 20, thereby preventing the clothing from being damaged by the moving hanger 100.

In one example, the moving hanger 100 may reciprocally rotate only one of the plurality of power transmitters 400.

In some examples, when only one power transmitter 400 rotates, there is a risk that clothing hung on the rotating power transmitter may collide with clothing hung on another power transmitter 400, which may damage the clothing or damage the moving hanger 100.

In some implementations, the moving hanger 100 rotates all of the plurality of power transmitters 400. In addition, the moving hanger 100 may simultaneously rotate the plurality of power transmitters 400 at the same angle. This prevents the power transmitters 400 from colliding with each other.

In one example, in the moving hanger 100, it may be advantageous in controlling the rotation of all of the power transmitters 400 that the power of the driver 200 is directly transmitted to all of the plurality of power transmitters.

In some examples, when the driver 200 includes a plurality of drivers to transmit the power to the respective power transmitters 400, not only an excessive load may be applied onto the inner casing 20, but also an inconvenience of having to control the plurality of drivers 200 may occur.

Therefore, the moving hanger 100 may be equipped such that one driver 200 rotates the plurality of power transmitters 400.

In this regard, when the displacement generator 300 and the power-to-rotation converter 500 are connected to each other to transmit the power transmitted from one driver 200 to all of the power transmitters 400, an arrangement and structures of the displacement generator 300 and the power-to-rotation converter 500 may become complicated, and thus reliability may decrease.

Therefore, the moving hanger 100 of the present disclosure may transmit the power generated from the driver 200 to only some of the plurality of power transmitters 400.

The power-to-rotation converter 500 may transmit the power transmitted from the driver 200 or the displacement generator 300 to only some of the power transmitters 400.

Therefore, because a configuration of the power-to-rotation converter 500 becomes simple, reliability of transmitting the power may be secured.

In one example, the moving hanger 100 may further include the connector 600 that transmits the power transmitted to the specific power transmitter 400 to another power transmitter 400.

For example, the connector 600 may connect the plurality of power transmitters 400 to each other. Accordingly, when one power transmitter 400 rotates, all adjacent or spaced power transmitters 400 may rotate.

Specifically, the moving hanger 100 may transmit the power of the driver 200 to only one of the plurality of power transmitters 400, and transmit the power transmitted to the power transmitter to the remaining power transmitters 400 via the connector 600.

The displacement generator 300 or the power-to-rotation converter 500 may intensively transmit the power generated by one driver 200 to one power transmitter 400. Further, the connector 600 may transmit the power transmitted to the specific power transmitter 400 to all of the power transmitters 400.

The connector 600 may be formed as a rigid body to connect all of the power transmitters 400 to each other, and all of the power transmitters 400 may rotate in the same direction and at the same angle at the same time because of the connector 600.

Accordingly, the moving hanger 100 of the present disclosure may reciprocally rotate the plurality of power transmitters 400 at the same time or simultaneously at the same angle using one driver 200 with the simple configuration.

FIG. 8 shows a structure of the moving hanger 100.

The moving hanger 100 may include the driver 200 that is fixed on the inner casing 20 and provides the power for moving the power transmitter, a plurality of power-to-rotation converters 500 that are respectively coupled to the plurality of power transmitters 400 to receive the power from the driver 200 and rotate such that a rotation direction thereof repeatedly changes, and the connector 600 that connects the plurality of power-to-rotation converters to each other.

The connector 600 may include a singular link that connects the plurality of power-to-rotation converters 500 to each other and rotates the plurality of power-to-rotation converters 500 integrally.

The connector 600 may also connect the power transmitters 400 to each other.

When the connector 600 connects the power-to-rotation converters 500 to each other, the connector 600 may be installed above the support 800, so that the connector 600 may not be exposed inside the inner casing 20.

When the connector 600 is equipped as the singular link, interference between the driver 200 and the connector 600 may be decreased.

For example, the singular link may be coupled to a front portion or a rear portion of the power-to-rotation converter 500, and the displacement generator 300 or the driver 200 to be described below may be disposed at the rear of or in front of the power-to-rotation converter 500.

The connector 600 may reciprocally move in the width direction of the inner casing 20 and rotate the plurality of power-to-rotation converters 500.

The driver 200 may include the motor 210 that rotates the rotation shaft 220, the power shaft 240 that rotates together when the rotation shaft 220 rotates, and the transmitter 230 that connects the power shaft 240 with the rotation shaft 220 to transmit a rotational power of the rotation shaft 220 to the power shaft 240.

The motor 210 may be fixed on the inner casing 20 and rotate the rotation shaft 220. In some examples, the rotation shaft 220 is constructed to rotate at a speed that is too high compared to an appropriate cycle for the motor 210 to reciprocally rotate the power transmitter 400. There is a concern that when an RPM of the rotation shaft is lowered considering the above, an output of the motor 210 may not be transmitted to the power transmitter 400.

In some examples, the transmitter 230 may transmit an output of the rotation shaft 220 as it is to the power transmitter 400, but transmit the same by lowering the RPM of the rotation shaft 220.

The transmitter 230 may be connected to the rotation shaft 220 and rotate, where transmitter 230 may rotate with a diameter larger than that of the rotation shaft 220. Accordingly, the transmitter 230 may transmit a torque of the rotation shaft 220 while rotating at an RPM lower than the RPM of the rotation shaft 220.

The power shaft 240 may be rotated by the transmitter 230, may be formed separately from the rotation shaft 220, and may directly transmit the power to the power transmitter 400.

The power-to-rotation converter 500 may be coupled to the power transmitter 400 and be rotatable together with the power transmitter 400.

The power-to-rotation converter 500 may include a reciprocating lever 510 coupled to an upper portion of the power transmitter 400 to rotate the power transmitter 400.

The reciprocating lever 510 may be formed in a rib or bar shape with a center of rotation coupled to a support shaft 410.

The reciprocating levers 510 may be respectively coupled to upper ends of the plurality of power transmitters 400, and some of the reciprocating levers 510 may be connected to the transmitter 230 and receive the power from the motor 210.

The reciprocating lever 510 may reciprocally rotate at a predetermined angle when the transmitter 230 is rotated by the motor 210. The power transmitter 400 may be coupled to a rotation center of the reciprocating lever 510 and rotate together with the reciprocating lever 510.

The plurality of reciprocating levers 510 may be connected to each other by the connector 600.

The connector 600 may connect respective one ends of the plurality of reciprocating levers 510 to each other.

Accordingly, when any one of the plurality of reciprocating levers 510 rotates, the connector 600 may move, so that the plurality of reciprocating levers 510 may rotate simultaneously and at the same time.

The power transmitter 400 and the reciprocating lever 510 may be supported by the support 800. In addition, the motor 210 and the transmitter 230 may also be supported by the support 800.

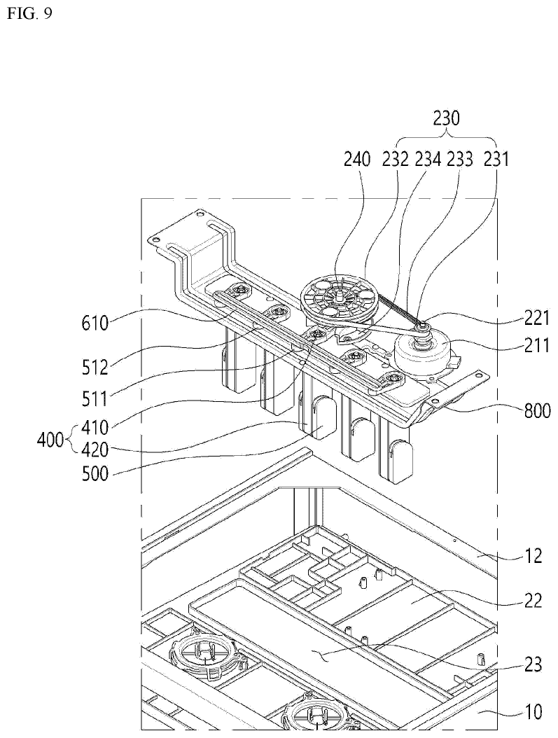

FIG. 9 shows the moving hanger 100 of the present disclosure separated from the inner casing 20.

The power transmitter 400 may extend downwards from above the inner casing, and the hanger 700 may be coupled to the lower portion of the power transmitter 400.

The power-to-rotation converter 500 may be coupled to each power transmitter 400, and may be coupled to the upper portion of the power transmitter 400 to be easily connected to the driver 200.

The power transmitter 400 and the power-to-rotation converter 500 are respectively include the plurality of power transmitters and the plurality of power-to-rotation converters that are arranged to be spaced apart from each other at a predetermined distance along the width direction of the inner casing.

The connector 600 connects the plurality of power transmitters 400 or the plurality of power-to-rotation converters 500 to each other. Thus, the connector 600 may rotate an entirety of the plurality of power transmitters 400 or the plurality of power-to-rotation converters 500 simultaneously.

The power transmitter 400 may include the support shaft 410 that extends through the upper portion of the inner casing 20 and is coupled to the reciprocating lever 510.

The support shaft 410 may extend through the support 800 and be exposed upwardly of the support 800 or the inner casing 20.

The power transmitter 400 may include an auxiliary support 420 coupled to the support shaft 410 and exposed to the accommodating space. The auxiliary support 420 may be formed in a rod shape and allow the hanger 700 to be coupled and fixed to a lower portion thereof.

The auxiliary support 420 may be fixed to the support shaft 410 and rotate together with the support shaft 410. Accordingly, when the support shaft 410 is rotated by the above reciprocating lever 510, the auxiliary support 420 coupled to the support shaft 410 may also rotate, thereby allowing the hanger 700 to rotate left and right.

The reciprocating levers 510 may include a main lever 511 that receives the power directly from the driver 200 and reciprocally rotates, and an auxiliary lever 512 that receives the power from the main lever 511 via the connector 600.

The main lever 511 may be equipped in a single part and may directly receive the power from the driver 200.

In the driver 200, the motor 210 may include a vertical motor 211 coupled to the support 800, and a vertical rotation shaft 221 that rotates by the vertical motor 211.

The transmitter 230 may include a power pulley 231 that is coupled to the vertical rotation shaft 221 and rotates together with the vertical rotation shaft 221, a transmission pulley 232 that is coupled to the power shaft 240 and rotates the power shaft 240, and a belt 233 that connects portions of outer circumferential surfaces of the power pulley 231 and the transmission pulley 232 to each other.

The transmitter 230 may further include a pulley support 224 that rotatably supports the power shaft 240 and the transmission pulley 232. The pulley support 224 may support the transmission pulley 232 so as to be disposed in parallel with the power pulley 231, and may be seated on the support 800.

The power shaft 240 may transmit the power transmitted from the rotation shaft 220 to one of both ends of the main lever 511.

The power shaft 240 may be coupled with the displacement generator 300, which will be described later, to reciprocally rotate the main lever 511 around the support shaft 410.

The connector 600 may include a link bar 610 connecting one end of the auxiliary lever 512 with one of both ends of the main lever 511 that is not connected to the power shaft 240.

The auxiliary lever 512 may be rotatably coupled with the support shaft 410, and may extend in one direction from a portion coupled with the support shaft 410 and be connected to the link bar 610.

The link bar 610 may be formed in a shape of a straight frame connecting one end of the main lever 511 and respective one ends of the auxiliary levers 512 to each other. In this regard, the one end of the main lever 511 and the respective one ends of the auxiliary levers 512 may be arranged parallel to each other based on the link bar 610 or the width direction.

The link bar 610 may be equipped in a single part so as to rotate the main lever 511 and the auxiliary levers 512 around the respective support shafts 410 thereof simultaneously and at the same time.

The inner casing 20 may include a through-hole 23 in which a portion of the support 800 is seated to expose the power transmitter 400 to the accommodating space 21.

The through-hole 23 may be defined in a top surface 22 of the inner casing, and the through-hole 23 may be defined along the direction in which the power transmitters 400 are arranged.

For example, the power transmitters 400 may be arranged to be spaced apart from each other along the width direction of the inner casing, and the through-hole 23 may be defined along the width direction of the inner casing.

The clothing treating apparatus 1 of the present disclosure may further include a support frame 12 disposed outside the inner casing to support the cabinet 10.

The support frame 12 may be disposed at each location corresponding to a corner of the cabinet 10 or a corner of the inner casing 20, and may be made of a metal material to maintain the outer appearance of the clothing treating apparatus. As both ends of the support 800 may be seated and supported on the support frames 12, transmission of impact or load to the top surface 22 of the inner casing may be prevented.

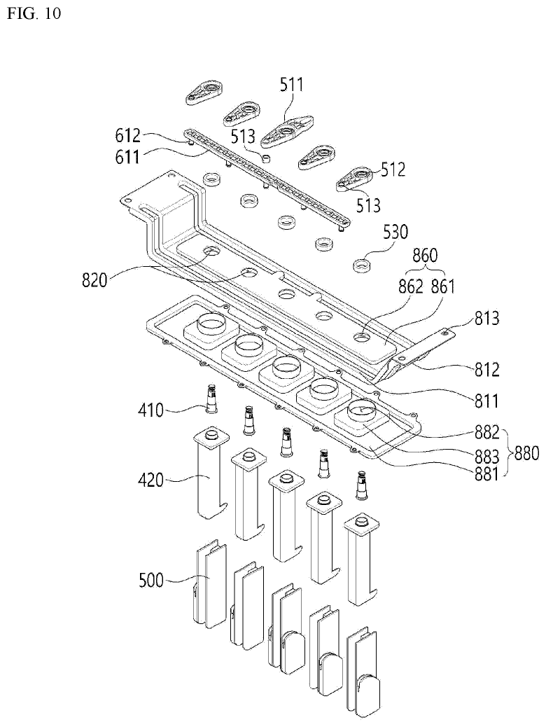

FIG. 10 is an exploded perspective view of the moving hanger 100 of the present disclosure.

The power transmitter 400 may include the support shaft 410 that extends through the top surface of the inner casing 20 and is coupled to the reciprocating lever 510, the auxiliary support 420 that is coupled to the support shaft 410 and is exposed to the accommodating space 21, and the hanger 700 that is coupled to the auxiliary support 420 and hangs the clothes hanger 900 or the clothes thereon.

The support shaft 410 may be formed in a cylindrical shape whose length is greater than a diameter and may be easily rotated by the reciprocating lever 510.

The support shaft 410 may have a diameter much smaller than that of the auxiliary support 420, thereby extending through the inner casing or the support 800 with a smaller area size. Therefore, a possibility of hot air or steam supplied to the accommodating space leaking upward of the inner casing 20 may be further reduced.

The auxiliary support 420 may have a cross-sectional area greater than that of the support shaft 410, and have a length greater than that of the support shaft 410. Accordingly, the auxiliary support 420 may secure a rigidity and an area size to support and rotate the hanger 700 and the clothes hanger 900.

The support 800 may include a support plate 810 through which the support shaft 410 extends and on which the driver 200 may be supported. The support plate 810 may be equipped as a metal plate to ensure rigidity and durability, and may extend in the direction in which the plurality of power transmitters 400 are arranged.

The support 800 may include an extending body 812 extending upward from both ends of the support plate 810 to define a space in which the driver 200 and the power-to-rotation converter 500 are seated between the inner casing 20 and an upper portion of the cabinet 10, and a seating body 813 extending from the extending body 812 to be seated on the support frame 12.

The support 800 may include a shaft coupling portion 820 through which the support shaft 410 extends.

The shaft coupling portion 820 may include a plurality of shaft coupling portions so as to be located at locations corresponding to locations where the power transmitters 400 are arranged, and the plurality of shaft coupling portions may be arranged to be spaced apart from each other along a length direction of the support plate 810.

In one example, the support 800 may further include an auxiliary plate 880 coupled to the support plate 810 from below. The auxiliary plate 880 may be made of a resin-based material, and may accommodate a portion of the outer circumferential surface of the power transmitter 400.

The auxiliary plate 880 may include a plurality of accommodating holes 882 that are defined under the support plate 810 and are able to rotatably accommodate the respective power transmitters 400 therein, a plurality of extending steps 883 extending with a greater width from the respective accommodating holes 882, and a fixing plate 881 that extends from the extending steps 883 to face the support plate 810 and is able to be coupled and fixed to the support plate 810.

The accommodating hole 882 may be defined at an upper end of the support shaft 410 or the auxiliary support 420 to prevent hot air or air from being discharged to the shaft coupling portion 820. The extending step 883 may serve to disperse a load or an impact transmitted to the auxiliary plate 880, and may serve to prevent collision or interference between the accommodating hole 882 and the clothes hanger 900.

The support 800 may further include a seating plate 860 seated on the support plate 810.

The seating plate 860 may support a bearing seated in the shaft coupling portion 820, and at the same time, prevent the reciprocating lever 510 and the connector 600 from colliding with or rubbing against the support plate 810.

The seating plate 860 may include a seating board 861 seated on the support plate 810 and a seating hole 862 positioned in an area corresponding to the shaft coupling portion 820 by extending through the seating board 861.

The reciprocating lever 510 may include the main lever 511 that directly receives the power from the driver 200, and the auxiliary lever 512 that receives the power from the main lever 511 via the connector 600.

The main lever 511 and the auxiliary lever 512 may be coupled to the respective support shafts 410 and may rotate around the support shafts 410.

The link bar 610 may include a link body 611 that may be seated on the main lever 511 and the auxiliary lever 512 and connect them to each other, and connecting hooks 612 that protrude from the link body 611 and are rotatably connected to the main lever 511 and the auxiliary levers 512.

The reciprocating lever 510 may include a link bearing 513 that is coupled to each of one end of the main lever 511 and one end of the auxiliary lever 512 and rotatably supports the connecting hook 612.

When the link bar 610 rotates left and right, the main lever 511 or the auxiliary lever 512 may reciprocally rotate left and right.

The power-to-rotation converter 500 may further include a support bearing 530 that may rotatably support the support shaft 410 or the reciprocating lever 510.

The support bearing 530 may rotatably accommodate therein the support shaft 410 and may be seated in the shaft coupling portion 620.

The reciprocating lever 510 may be disposed on the support bearing 530.

The support bearing 530 may be composed of a plurality of stacked pieces or may be equipped as a ball bearing or an oilless bearing.

The seating plate 860 may support the support bearing 530 and may block hot air or moisture from being exposed from an outer circumferential surface of the support bearing 530.

In addition, the auxiliary plate 880 may also be disposed at a lower portion of the support bearing 530 to block hot air or moisture from being exposed from the outer circumferential surface of the support bearing 530.

FIG. 11 shows an operating method of the moving hanger 100 of the present disclosure.

Referring to (a) in FIG. 11, the main lever 511 may include a main body 5111 coupled to the support shaft 410 and coupled to the connecting bar 630.

The main body 5111 may include a main center hole 5115 that may be coupled to the support shaft 410 and rotate the support shaft 410, and may extend in both lateral directions from the main center hole 5115.

The main body 5111 may include a main receiving hole 5112 that receives the power from the driver 200 at one end, and may include a main transmission hole 5113 at the other end into which the connecting bar 630 is installed and coupled.

The main body 5111 may further include a step 5114 that extends from the center hole to the main receiving hole 5112 but forms a step. Because of the step 5114, one end of the main body 5111 or the main transmission hole 5113 may be positioned downward of the main center hole 5115.

As a result, a length of the power shaft 240 or the eccentric shaft 310 to be described later, which is disposed on the main center hole 5115, extending from the transmitter 230 may be secured.

In one example, the auxiliary lever 512 may include an auxiliary body 5121 having an auxiliary center hole 5125 coupled to the support shaft 410 and an auxiliary transmission hole 5123 that extends to one side from the auxiliary center hole 5125 and is coupled to the link bar 610.

The auxiliary body 5121 may have a length smaller than that of the main body 5111.

A distance from the main center hole 5115 to the main transmission hole 5113 may be set to be the same as a distance from the auxiliary center hole 5125 to the auxiliary transmission hole 5123.

The link bar 610 may be seated on the auxiliary transmission hole 5123 and the main transmission hole 5113 to connect the auxiliary lever 512 with the main lever 511.

Referring to (b) in FIG. 11, the driver 200 may be equipped such that the power shaft 240 is inserted into the main receiving hole 5112. Accordingly, the driver 200 may be equipped so as to directly rotate the power shaft 240 to rotate the main receiving hole 5112 left and right.

In other words, the rotation of the power shaft 240 alone may not generate sufficient displacement to rotate the main receiving hole 5112 left and right with respect to the main center hole 5115.

In some examples, the moving hanger 100 of the present disclosure may include the displacement generator 300 that is coupled to the power shaft 240 and is able to generate a displacement greater than the rotation radius of the power shaft 240.

The displacement generator 300 may convert the stationary rotational motion of the power shaft 240 into a displacement motion of reciprocally moving within a predetermined range. The displacement motion may be transmitted to the power-to-rotation converter 500, so that the power transmitter 400 may reciprocally rotate.

For example, the displacement generator 300 may further include the eccentric shaft 310 that extends from the power shaft 240 and rotates along a trajectory of a predetermined radius.

The diameter of the eccentric shaft 310 may be set to be smaller than a diameter or a width of the main receiving hole 5112. Accordingly, the eccentric shaft 310 may be inserted into and supported by the main receiving hole 5112.

In some examples, the predetermined radius of rotation of the eccentric shaft 310 may be set to be greater than the width or the diameter of the main receiving hole 5112. As a result, when the eccentric shaft 310 rotates, the main receiving hole 5112 may be pushed by the eccentric shaft 310 and may move left and right around the main center hole 5115.

As a result, when the eccentric shaft 310 rotates in a specific direction x, the main receiving hole 5112 of the main body 5111 may also reciprocally rotate along a certain direction y, and as a result, the main center hole 5115 of the main body may also rotate in the same direction as the main receiving hole 5112 and the main transmission hole 5113 may reciprocally rotate in a direction z opposite to the certain direction.

When the eccentric shaft 310 rotates, the support shaft 410 may reciprocally rotate with the main center hole 5115 and thus the power transmitter 400 may reciprocally rotate. Further, the main transmission hole 5113 may also reciprocally rotate to reciprocally move the link bar 610, so that the auxiliary lever 512 may also reciprocally rotate around the auxiliary center hole 5125 and the support shaft 410. The power transmitter 400 coupled to the auxiliary lever 512 may also reciprocally rotate.

The power transmitter 400 may have a screw thread along a circumference of an upper portion of the support shaft 410.

The main transmission hole 5113 and the auxiliary center hole 5125 may be directly coupled and fixed to the support shaft 410 using the screw thread or the like.

In some examples, the power transmitter 400 may further include a transmission coupling portion 415 that extends through the main transmission hole 5113 and the auxiliary center hole 5125 as it is and then is coupled to the screw thread of the support shaft 410 so as to fix the support shaft 410 to the main transmission hole 5113 and the auxiliary center hole 5125.

Therefore, the support shaft 410 and the reciprocating lever 510 may be coupled to each other by the transmission coupling portion 415, so that the support shaft 410 and the reciprocating lever 510 may rotate simultaneously.

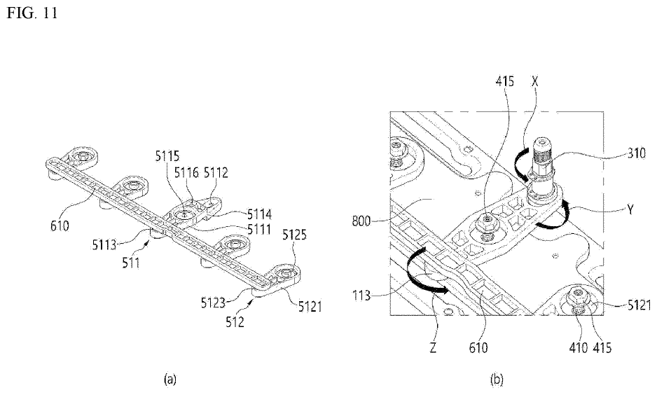

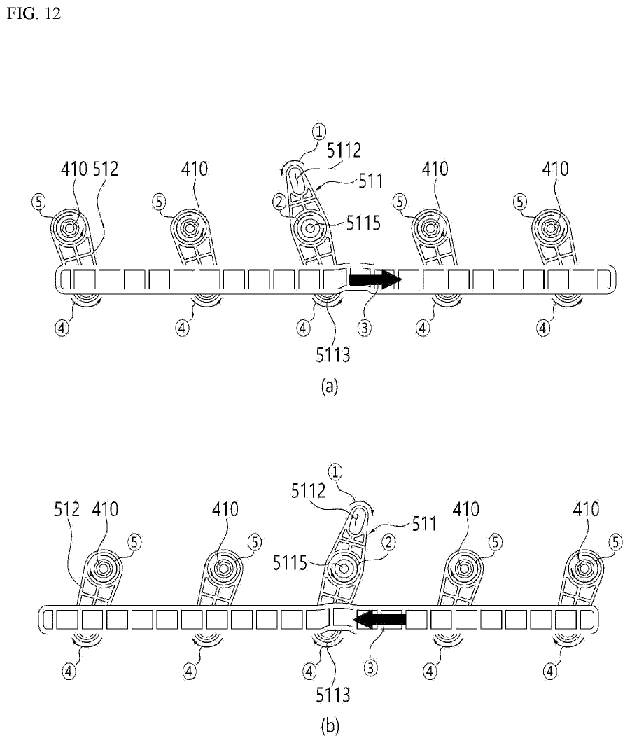

FIG. 12 shows an operation process of the moving hanger 100 of the present disclosure.

Referring to (a) in FIG. 12, the main receiving hole 5112 in the main lever 511 may rotate to the left with respect to the main center hole 5115 by the rotation of the eccentric shaft 310 (No. 1).

When the main receiving hole 5112 rotates to the left, the main center hole 5115 may also rotate counterclockwise (No. 2). In such process, the power transmitter 400 coupled to the main center hole 5115 may rotate counterclockwise.

The main receiving hole 5112 rotates counterclockwise around the main center hole 5115. In this regard, the link bar 610 may move to the right as the main receiving hole 5112 moves (No. 3).

When the link bar 610 moves to the right, the auxiliary transmission hole 5123 in the auxiliary lever 512 rotates counterclockwise with respect to the auxiliary center hole 5125. Because the link bar 610 is connected to the plurality of auxiliary levers 512, all of the auxiliary levers 512 rotate counterclockwise (No. 4).

When the auxiliary lever 512 rotates counterclockwise, the power transmitter 400 coupled to the auxiliary center hole 5125 also rotates counterclockwise (No. 5).

Referring to (b) in FIG. 12, the main receiving hole 5112 in the main lever 511 may rotate to the right with respect to the main center hole 5115 by the rotation of the eccentric shaft 310 (No. 1).

When the main receiving hole 5112 rotates to the right, the main center hole 5115 may also rotate clockwise (No. 2). In such process, the power transmitter 400 coupled to the main center hole 5115 may rotate clockwise.

The main receiving hole 5112 rotates clockwise around the main center hole 5115. In this regard, the link bar 610 may move to the left as the main receiving hole 5112 moves (No. 3).

When the link bar 610 moves to the left, the auxiliary transmission hole 5123 in the auxiliary lever 512 rotates clockwise with respect to the auxiliary center hole 5125. Because the link bar 610 is connected to the plurality of auxiliary levers 512, all of the auxiliary levers 512 rotate clockwise (No. 4).

When the auxiliary lever 512 rotates clockwise, the power transmitter 400 coupled to the auxiliary center hole 5125 also rotates clockwise (No. 5).

When such process is repeated, the main lever 511 may receive the power from the driver 200 and reciprocally rotate clockwise and counterclockwise to reciprocally rotate the power transmitter 400 coupled to the main lever 511 and reciprocally move the link bar 610 left and right.

The link bar 610 may reciprocally rotate the auxiliary lever 512 while reciprocally rotating left and right, and may reciprocally rotate the power transmitter 400 coupled to the auxiliary lever 512.

The link bar 610 is formed as a rigid body, and the auxiliary lever 512 and the main lever 511 are coupled to the link bar 610 at locations spaced apart from the respective support shafts 410 by the same distance.

Therefore, because of the link bar 610, the auxiliary levers 512 and the main lever 511 may reciprocally rotate by the same angle, and as a result, all of the power transmitters 400 may rotate at the same angle simultaneously and at the same time, and reciprocating rotation angles thereof may also be equal to each other.

The main lever 511 may be disposed between the auxiliary levers 512. In addition, the auxiliary levers 512 may be arranged symmetrically with respect to the main lever 511. As such, a load may be evenly applied to both sides of the connecting bar 630 connected to the main lever 511.

In some examples, when the power of the main lever 511 is able to be transmitted to the auxiliary lever 512, the main lever 511 and the auxiliary levers 512 may be arranged in any arrangement or order.

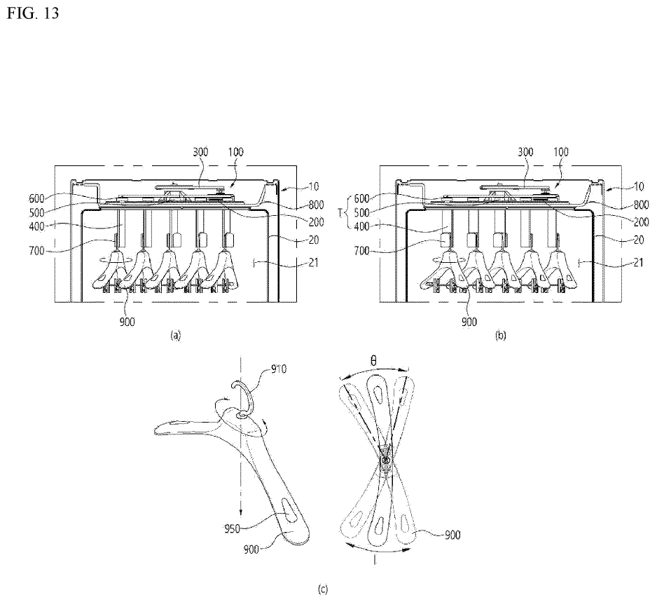

FIG. 13 shows an operating scheme of a moving hanger of the present disclosure.

Referring to (a) in FIG. 13, the power transmitter 400 may rotate to the right by the power-to-rotation converter 500 when the driver 200 operates. In this regard, the power transmitters 400 connected to the connector 600 may also rotate to the right.

Referring to (b) in FIG. 13, the power transmitter 400 may rotate to the left by the power-to-rotation converter 500 when the driver 200 further operates. In this regard, the power transmitters 400 connected to the connector 600 may also rotate to the left.

As such process is repeated, the power transmitter 400 may rotate left and right.

In this regard, the power transmitter 400 may rotate left and right while being fixed in place. The power transmitter 400 may be fixed to the support 800 such that there is no change in location in a front and rear direction and a left and right direction when rotating.

The power transmitter 400 may be fixed such that the location thereof does not change in a vertical direction, the front and rear direction, and a width direction.

In some examples, the power transmitter 400 may rotate left and right with the vertical or height direction in which the power transmitter extends as a rotation shaft. As a result, when the driver 200 operates, the hanger 700 may rotate left and right around the power transmitter 400 and there may be no location change.

Referring to (c) in FIG. 13, the clothes hanger 900 may include a ring 910 hung on the hanger 700 and a seating portion 950 coupled to the ring 910. A surface portion that prevents the clothing from slipping may be formed on a surface of the seating portion 950.

The seating portion 950 may be formed to be bilaterally symmetrical about the ring 910. The clothes hanger 900 may be hung on the hanger 700 such that the seating portion 950 is disposed in the front and rear direction.

When the power transmitter 400 rotates to the left, in the clothes hanger 900, a left side of the seating portion 950 may rotate to the left and a right side of the seating portion 950 may rotate to the right, based on the ring 910. In this regard, an angle I at which the left side of the seating portion 950 rotates may be equal to an angle (theta) at which the right side of the seating portion 950 rotates, and a distance at which the left side of the seating portion 950 moves may be equal to a distance at which the right side of the seating portion 950 moves.

As a result, based on the clothes hanger 900, a weight and a force of moving to the left and a weight and a force of moving to the right may be equal to each other and thus may be offset from each other.

Likewise, even when the power transmitter 400 rotates to the right, based on the clothes hanger 900, the weight and the force of moving to the left will be equal to the weight and the force of moving to the right, and thus they will be offset from each other.

As a result, even when the power transmitter 400 rotates, the forces applied to the clothes hanger 900 may be offset from each other, and as a result, a vibration force or an excitation force or an inertial force generated from the clothes hanger 900 itself may be decreased. Accordingly, an inertial force or the like generated from the plurality of power transmitters 400 may be decreased, so that vibration or noise generated from the entire moving hanger 100 may be decreased and vibration or noise generation from the entire clothing treating apparatus 1 may be drastically reduced.

As a result, even when the driver 200 operates at a maximum output, the vibration generated from the entire moving hanger 100 or the entire clothing treating apparatus 1 may not be generated.

Instead, because each of surfaces of the clothing items hung on the clothing hangers 900 rotates left and right and shakes off dust, a force of removing dust may be greatly secured.

In addition, the power transmitter 400 may extend through the inner casing 20 and receive the power to reciprocally rotate clockwise and counterclockwise.

The power transmitter 400 may reciprocally rotate left and right while the location thereof is fixed at the upper portion of the accommodating space 21.

The power transmitter 400 is fixed so as not to vary in location in the vertical direction and the left and right direction. In addition, not only the upper portion but also the lower portion of the power transmitter 400 is fixed so as not to change a location thereof in the vertical direction and the left and right direction.

That is, the power transmitter 400 may reciprocally rotate by a certain angle less than one rotation while the rotation center thereof is fixed.

No matter how fast the power transmitter 400 rotates, the location of the power transmitter 400 is fixed.

Therefore, the vibration and the noise generated by the power transmitter 400 inside the inner casing 20 may be decreased.

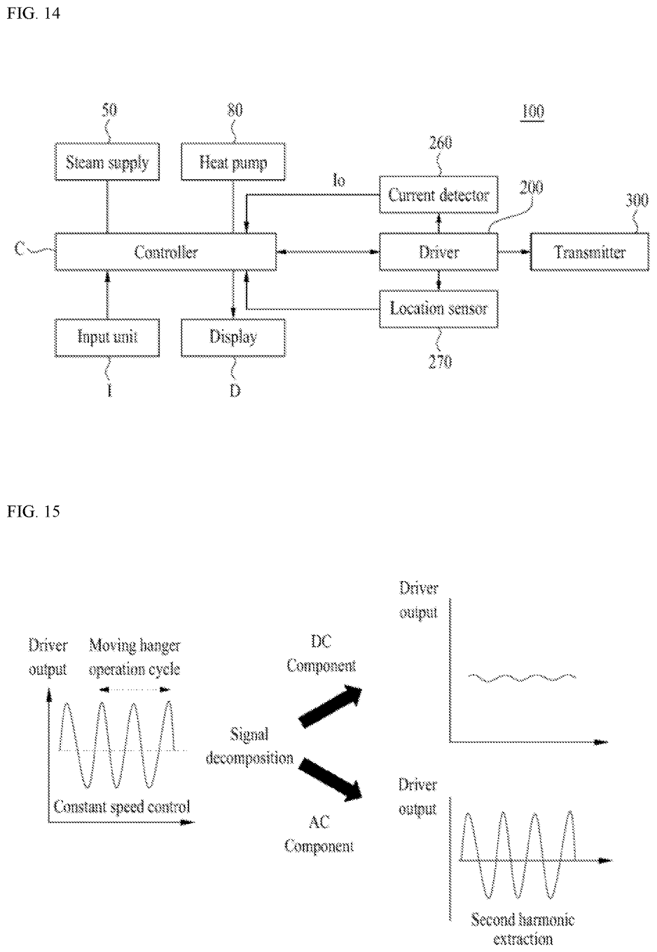

FIG. 14 shows a system in which the moving hanger operates.

The clothing treating apparatus of the present disclosure may include a controller C that operates one or more of the moving hanger 100, the steam supply 50, and the heat pump system 80 to perform an arbitrary course for treating the clothing.

The controller C may perform various courses composed of a series of control methods that may perform the refresh cycle such as the drying, the deodorization, the sterilization, and the wrinkle removal of the clothing. For example, the controller C may include an electric circuit, a processor, a microprocessor, a computer, etc.

The clothing treating apparatus of the present disclosure may further include an input part I that inputs a command to perform the course to the controller C, and a display D that receives information from the controller C and displays a state of the clothing treating apparatus. The input part I and the display D may be disposed on one of the cabinet 10 and the door 11.

The controller C may operate the moving hanger 100 when the command to perform the course is input from the input part I or the like or a command to receive power is input.

The controller C may operate the moving hanger 100 by operating the driver 200. The driver 200 may receive a command from the controller C and operate the transmitter 230 to oscillate the clothing.

The controller C may provide a signal to directly operate the driver 200 and may also receive information of the driver 200.

The clothing treating apparatus of the present disclosure may include a current detector 260 that receives electrical information such as current and voltage output from the driver 200 and transmits the same to the controller C.

In addition, the clothing treating apparatus of the present disclosure may include a location sensor 270 that senses the location of the power transmitter 400 or the connector 600 and transmits the same to the controller C. The location sensor 270 may sense the rotation angles of the rotation shaft 220 and the power shaft 240 or the location of the eccentric shaft 310.

The clothing treating apparatus of the present disclosure may sense clothing information including at least one of the weight, the length, the material, characteristics, and the type of the clothing based on a control system that operates the moving hanger 100. The clothing treating apparatus of the present disclosure may optimize and adjust at least one of an intensity, a type, a time, and an option value of a refresh course that treats the clothing based on the sensed clothing information.

For example, the clothing treating apparatus of the present disclosure may operate by adjusting at least one of the operating speed of the moving hanger 100, an operating time and an operating output of the steam supply 50, and an operating time and an operating rpm of the heat pump system 80 based on the sensed clothing information.

The operating speed of the moving hanger 100 may be defined as one of an operating rpm of the driver 200 or the moving speed of the power transmitter 400.

The operating speed of the moving hanger 100 may also be defined based on a speed at which the clothing oscillates or a speed at which the upper end of the clothing oscillates.

The clothing treating apparatus of the present disclosure may differently adjust, based on the sensed clothing information, a mechanical power applied to the clothing, an amount of steam supplied to the clothing and a steam exposure time, and a temperature of hot air supplied to the clothing and a hot air exposure time.

Accordingly, the clothing treating apparatus of the present disclosure may treat the clothing in a customized manner based on the clothing information, rather than performing a standardized course regardless of the clothing information.

In one example, the clothing treating apparatus of the present disclosure may be equipped with a separate sensor to sense the clothing information. For example, the clothing treating apparatus of the present disclosure may be equipped with a load sensor or the like installed on the moving hanger 100 to sense the weight of the clothing, and may be equipped with a radar sensor using light, radio waves, or the like, or the location sensor 270 inside the inner casing to sense the length, the material, the type, and the like of the clothing.

In some examples, when multiple sensors that directly sense the clothing information are installed in the clothing treating apparatus, not only will production and repair costs increase, but it may also be difficult to maintain durability of the sensors because of the nature of hot air and steam being supplied into the clothing.

In some examples, the clothing treating apparatus of the present disclosure may allow the controller C to calculate the electrical information applied to or output from the moving hanger 100 while operating the moving hanger 100.

The electrical information may include one or more of a current value, a power value, a waveform of the current or the power, an amplitude, and a period applied to or output from the motor 210 while operating the driver 200.

Usually, in a washing machine, a dryer, and the like, the weight of the clothing is calculated by analyzing a current value output from the driver that rotates the drum that accommodates the clothing therein. This is available because the clothing items accommodated in the washing machine and the dryer are lumped together inside the drum regardless of the type, the material, and the length of the clothing. In other words, in the washing machine and the dryer, the current value to rotate the driver or the current value output from the driver is determined based on the weight of the clothing regardless of a condition of the clothing, and there are almost no variables that affect the current value.

In some examples, in the clothing treating apparatus of the present disclosure like a clothing manager, the clothing is placed in a state in which only the upper portion is hung on the moving hanger 100 and the rest droops in the accommodating space 21. As a result, when the moving hanger 100 operates, the clothing vibrates along the height direction while forming various waveforms.

In other words, the clothing vibrates independently of the vibration of the moving hanger 100, and the vibration generated from the clothing acts as a load on the moving hanger 100.

An amplitude or a vibration form generated from the clothing affects the current value or the power value applied to or output from the driver 200.

As a result, when the clothing treating apparatus of the present disclosure simply senses the weight of the clothing using only the electrical information while operating the moving hanger 100, reliability may be low.

For example, depending on the lengths of the clothing items, even when the clothing items vibrate at the same frequency, the vibration waveforms or the amplitudes thereof are different from each other. In addition, even when the weights of the clothing items are equal to each other, when the lengths thereof are different from each other, the vibration waveforms or the amplitudes thereof may be different from each other even when the clothing items oscillate at the same frequency. As a result, even when the motor 210 of the driver 200 operates at the same speed, when the lengths of the clothing items hung on the power transmitters 400 are different from each other, the controller may determine that the weights of the clothing items are different from each other.

When the moving hanger 100 operates slowly, the clothing may oscillate while moving along the moving hanger 100 from the upper portion to the lower portion as a whole. In some examples, when the moving hanger 100 operates quickly, the upper portion of the clothing may begin to oscillate with great amplitude and period, but the lower portion of the clothing may not be able to follow the vibration of the upper portion of the clothing or may follow the same late because of an inertial force, causing diffraction, such as bending of the clothing.

Furthermore, when an operating frequency of the moving hanger 100 or the power transmitter 400 corresponds to a resonant frequency of the clothing, the clothing may vibrate with a standing wave in which a vibrating area and a fixed area are fixed. When the clothing vibrates in the standing wave, an inertial force different from that when the clothing does not vibrate with the standing wave is transmitted to the moving hanger 100, which may cause a great error in the electrical information of the driver 200.

In addition, even when the clothing vibrates while forming the standing wave, the clothing may vibrate while varying a multiple (n) of the standing wave formed by the clothing depending on the operating speed of the driver 200 or the power transmitter 400. In this case, even when the clothing vibrates in the same standing wave, a different inertial force may be provided to the moving hanger 100, thereby providing an effect that causes the electrical information of the driver 200 to vary.

In summary, when the moving hanger 100 operates, the electrical information applied to the driver 200 and the electrical information output from the driver 200 are greatly affected by not only the weight of the clothing but also the vibration characteristics of the clothing. Because the vibration characteristics of the clothing depend on the operating speed of the driver 200 or the power transmitter 400, it may be seen that factors affecting the electrical information that may be sensed by the driver 200 are the weight of the clothing and the operating speed of the driver 200 or the power transmitter 400.

Therefore, the clothing treating apparatus of the present disclosure may calculate the clothing information including at least one of the weight and the length of the clothing while considering not only the weight of the clothing but also the vibration characteristics of the clothing based on the operating speed of the driver 200 or the power transmitter 400.

FIG. 15 shows an example in which a controller of a clothing treating apparatus of the present disclosure accurately calculates clothing information with a moving hanger.

The clothing treating apparatus of the present disclosure operates the moving hanger 100 by operating the driver 200 with the controller C.

The driver 200 may oscillate the clothing by reciprocally moving the power transmitter 400 via the transmitter 230 while continuously rotating the rotation shaft 220 and the power shaft 240 in one direction.

The reciprocating movement of the power transmitter 400 includes at least one of rectilinear reciprocating movement, reciprocal rotation at a constant angle, pendulum movement, and periodic movement of the power transmitter 400.

In other words, regardless of the implementation of the moving hanger 100, the moving hanger 100 installed in the clothing treating apparatus of the present disclosure may reciprocally move the power transmitter 400 by controlling the driver 200.

In the clothing treating apparatus of the present disclosure, when the moving hanger 100 operates, regardless of a manner in which the driver 200 and the transmitter 230 operate, the power transmitter 400 may change the moving direction of the hanger 700 twice per cycle.

Whenever the hanger 700 and the clothing hung on the hanger 700 via the clothes hanger 900 change the moving directions thereof, a considerable inertial force is generated. Accordingly, the hanger 700 transmits the inertial force to the power transmitter 400 twice during one reciprocating cycle.

When the hanger 700 reciprocally moves, the driver 200 is subjected to not only the load that moves the power transmitter 400 but also the inertial force. The driver 200 experiences an additional load each time it receives the inertial force periodically.

As a result, because the clothing generates the inertial force based on a certain cycle while the driver 200 operates, the electrical information output from the driver 200 or received via the driver 200 may include a graph that allows a movement state of the hanger 700 to be identified.

Therefore, the controller C of the clothing treating apparatus of the present disclosure may analyze the electrical information itself and the inertial force of the clothing that may be sensed from the electrical information to calculate the clothing information including the vibration characteristics of the clothing.

In addition, the controller C may sense the inertial force applied to the driver 200 to recognize the cycle of the reciprocating movement of the hanger 700 and also recognize a time point at which the hanger 700 changes the moving direction thereof.

In addition, the controller C may sense a magnitude of the inertial force and a change in the magnitude of the inertial force to also sense a movement state of the clothing.

For example, the clothing treating apparatus of the present disclosure may extract a DC component and an AC component from the electrical information when the controller C receives the electrical information from the driver 200.

The DC component, as an electrical signal having a certain absolute value, includes information on a load to operate the driver 200 at a specific RPM. Because the heavier the clothing is, the greater the load for the driver 200, the DC component may include information reflecting the weight of the clothing. Therefore, the controller C may obtain information to calculate the weight of the clothing by analyzing the DC component.

The AC component, as an electric signal having a certain period, may include information reflecting the vibration characteristics of the clothing. The inertial force may be transmitted to the driver 200 during the process in which the clothing vibrates or the hanger 700 periodically changes the moving direction thereof, and the transmitted inertial force may be reflected as the AC component.

The controller C may obtain information to calculate the vibration characteristics of the clothing, the vibration period of the clothing, and the like by analyzing the AC component.

In the case of having the certain period like the AC component, a second harmonic has the clearest signal in the periodic graph and has reliable information on period information. Therefore, the controller C may extract or select the second harmonic from the sensed AC components as a priority and analyze the vibration characteristics of the clothing in detail via the second harmonic.

The vibration characteristics of the clothing may vary depending on the length and the material of the clothing. Therefore, the vibration characteristics include the clothing information related to the length and the material of the clothing. Accordingly, the controller C may also calculate the clothing information, such as the length and the material of the clothing, using the vibration characteristics analyzed via the AC component analysis.

In addition, the controller C may additionally track and sense a change in the electrical information of the driver 200 by changing the operating speed of the driver 200 or the power transmitter 400, and may check the clothing information sensed in advance and recalculate the clothing information accordingly.

As a result, the controller C may calculate the clothing information by analyzing both an absolute value of the electrical information including at least one of the current and the voltage when operating the driver 200 and the vibration characteristics of the electrical information.

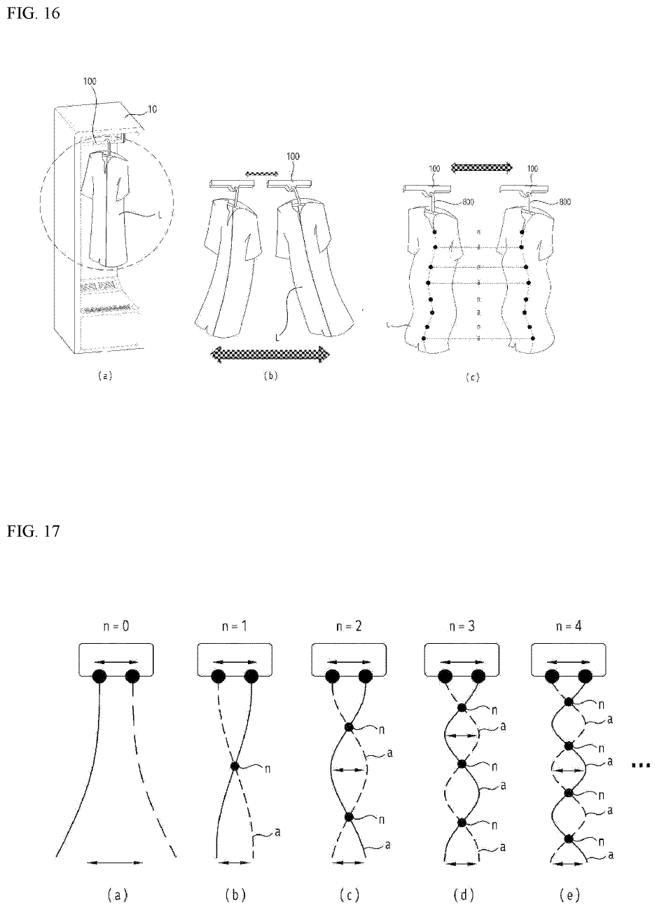

FIG. 16 shows an example of calculating a weight of clothing of a clothing treating apparatus of the present disclosure.

Referring to (a) in FIG. 16, in the clothing treating apparatus of the present disclosure, long clothing L may be disposed in an accommodating space 21 in a state of being hung on the moving hanger 100.

Referring to (b) in FIG. 16, the moving hanger 100 in the clothing treating apparatus of the present disclosure may operate the driver 200 to reciprocally move the power transmitter 400. The hanger 700 is coupled to the power transmitter 400 and the clothes hanger 900 is hung on the hanger 700, so that the clothes hung on the clothes hanger 900 may vibrate while reciprocally moving together with the power transmitter 400.

The moving hanger 100 may be operated at a specific frequency to oscillate the clothes supported by the power transmitter 400.

The moving hanger 100 being operated at the specific frequency means that the moving hanger 100 reciprocally moves periodically. In other words, the moving hanger 100 being operated at the specific frequency means that the power transmitter 400, which actually reciprocally moves the clothing, is operated at the specific frequency periodically. In addition, the driver 200 will operate at a specific speed to operate the power transmitter 400 at the specific frequency. That is, when the motor 210 is operated at the specific RPM, the power transmitter 400 may be operated at the specific frequency, and it may be defined that the moving hanger 100 is operated at the specific frequency.

When the moving hanger 100 starts operating at a low frequency, the long clothing L reciprocally moves along the power transmitter 400. In such process, an upper end of the clothing L moves together with the power transmitter 400, but as a distance from the power transmitter 400 increases, the inertial force acts on the clothing L and the clothing L tries to maintain a stationary state. As a result, the clothing moves in a state of lagging behind the upper end thereof and the lag increasing from the upper portion to the lower portion thereof. Therefore, a lower end of the clothing L moves in a state lagging behind the most in the clothing L.

In addition, when the power transmitter 400 stops to change the moving direction, the upper end of the clothing L stops together with the power transmitter 400, but the lower end of the clothing tries to maintain a state of moving by the inertial force. As a result, the lower portion of the clothing moves further than the upper portion thereof beyond the power transmitter 400, which results in a greater displacement of the lower end of the clothing.

When the frequency at which the moving hanger 100 or the driver 200 operates is lowered and the power transmitter 400 reciprocally moves at a relatively low speed, an amplitude at which the lower end of the clothing reciprocally moves is greater than an amplitude at which the upper end of the clothing reciprocally moves.

In such situation, when the frequency at which the moving hanger 100 or the driver 200 operates becomes higher, the power transmitter 400 reciprocally moves faster than before, and a magnitude of the inertial force generated by the clothing L becomes greater. As a result, the displacement difference between the lower end of the clothing and the upper end of the clothing may become greater.

In addition, when the power transmitter 400 moves, the inertial force generated by the displacement difference in the entire clothing L acts as an additional load that the moving hanger 100 may bear. In addition, the load that the moving hanger 100 receives from the clothing may occur when the power transmitter 400 changes the moving direction.

Referring to (c) in FIG. 16, when the moving hanger 100 or the driver 200 operates at a higher frequency, the speed at which the power transmitter 400 reciprocally moves becomes higher. In this regard, the displacement difference between the upper and lower portions of the clothing causes directions in which the upper and lower portions of the clothing move to differ from each other.

In addition, when the displacement difference increases downward in the clothing and such movement aligns with the reciprocal motion of the power transmitter 400, sections of the clothing start moving in different directions from the upper portion to the lower portion, causing the clothing to vibrate while forming waveforms.

When the clothing vibrates, vibration energy is transferred to the moving hanger 100, which acts as an additional load applied to the driver 200.

In addition, when the moving hanger 100 operates at a higher frequency, the clothing vibrates while forming more waveforms. As a result, the clothing L does not move in the same direction as a whole, but moves in different directions from the upper portion to the lower portion, causing the entire clothing to vibrate.

In other words, when the driver 200 operates while accelerating from a low speed and then operates at a specific speed or higher, the clothing L is not able to move in the same direction as a whole, and the moving directions of the sections of the clothing become different from each other, so that the clothing may bend and diffract while forming the waveforms.

The occurrence of the diffraction in the clothing L may be defined as occurrence of points on the clothing L where the moving directions or amplitude directions are different from each other.

When the driver 200 operates at a speed equal to or higher than a speed that causes the diffraction in the clothing L, a node n that does not vibrate at least momentarily based on the moving hanger 100 and an antinode a that vibrates in the moving direction or a direction opposite thereto based on the moving hanger 100 are formed in the clothing L.

When the power transmitter 400 reciprocally moves faster, more nodes n and antinodes a are formed in the clothing L.

In addition, when the moving hanger 100 operates at the same frequency as the resonant frequency of the clothing, the clothing L may vibrate or diffract while forming the standing wave.

That the clothing vibrates in the standing wave means that the clothing vibrates such that a location of the node n that appears to be stationary on the clothing does not change over time when the clothing vibrates, and a location of the antinode a that vibrates with the greatest amplitude on the clothing also does not change over time.

The standing wave occurs whenever the moving hanger 100 operates at a multiple of n of the resonant frequency. As a result, whenever the driver 200 reaches a specific speed section, the clothing vibrates in the standing wave, so that the locations of the area where the node n is formed and the area where the antinode a is formed in the clothing may not vary.

The vibrations occurring in the clothing may be offset from each other when amplitude directions thereof are different from each other, and may not be completely transmitted to the moving hanger 100. When the clothing vibrates in the standing wave, a form of the vibrations occurring in the clothing may be symmetrical along the height direction of the clothing. As a result, when the clothing vibrates in the standing wave, most of the vibrations occurring in the clothing may be offset, and the vibrations transmitted to the moving hanger 100 may be decreased.

FIG. 17 shows a change in a vibration form of clothing based on an operating frequency of the moving hanger.

Referring to (a) in FIG. 17, when the moving hanger 100 operates at a frequency equal to or lower than a fundamental frequency, the clothing L may move in the same direction as a whole. When the moving hanger 100 operates at the fundamental frequency, areas of the clothing L may only have different amplitudes, and may have the same moving direction.

The fundamental frequency may be defined as an operating frequency of the moving hanger 100 at which the waveform or the vibration begins to occur on the clothing.

When the moving hanger 100 operates at a frequency equal to or lower than the fundamental frequency, no waveform occurs on the clothing, so the entire clothing may move in the same direction.

As a speed at which the driver 200 operates, a first speed may be defined as a speed at which the moving hanger 100 operates at the fundamental frequency. Until the driver 200 operates at the first speed at which the diffraction begins to occur on the clothing L from the stationary state, the entirety of the clothing L may have the same moving direction.

In other words, an amplitude of the upper end of the clothing and an amplitude of the lower end of the clothing may be different from each other, but the moving direction of the power transmitter 400 and the moving direction of the entire clothing may be the same.

Referring to (b) in FIG. 17, when the moving hanger 100 operates at a frequency equal to or higher than the fundamental frequency, the diffraction may occur in the clothing L. In addition, when the moving hanger 100 operates at the resonant frequency higher than the fundamental frequency, the clothing L may vibrate in the standing wave.

The clothing may vibrate while forming the standing wave whenever the frequency corresponds to n multiples of a minimum resonant frequency. Therefore, a minimum frequency at which the moving hanger 100 is able to initially vibrate the clothing in the standing wave may be defined as the minimum resonant frequency.

An operating speed of the driver 200 when the moving hanger 100 operates at the minimum resonant frequency may be defined as a second speed. The second speed may be set higher than the first speed. The second speed may be defined as a minimum resonant speed.

When the driver 200 operates at a speed equal to or higher than the first speed, the diffraction may occur in the clothing L. As a result, areas with different vibration directions may be formed in the clothing L along the height direction.

When the driver 200 operates at the second speed, the reciprocal cycle of the moving hanger 100 may correspond to an inverse of the resonant frequency of the clothing L, and the clothing L may vibrate in the standing wave.

When the clothing L vibrates in the standing wave, the location of the node n, which is an area without the vibration in the clothing L, is fixed, and the location of the antinode a, which is an area with the maximum amplitude, is also fixed.

When the driver 200 operates at the second speed and a first standing wave occurs in the clothing L, a single node n may be formed, and the number of antinodes a may be one more than the number of nodes n, including the upper end of the clothing.

In other words, when the driver 200 operates at the second speed, the clothing may oscillate at a first resonant frequency f1 and may vibrate in a first (n=1) standing wave.

The resonant frequency at which the clothing L vibrates in the standing wave may be determined as a unique characteristic of each clothing.

$${f}_{n} = \frac{v}{{λ}_{n}} = \frac{v}{2 l} n ( n = 1 , 2 , 3 … ) \qquad Equation ( 1 )$$

The Equation (1) represents a resonant frequency of the moving hanger 100 that may vibrate the clothing L while forming the standing wave.

A resonant frequency f corresponds to an inverse of a vibration period T or a reciprocal period T of the moving hanger 100.

In Equation (1), v is related to a tension and a linear density of the clothing and is able to be determined by fiber characteristics of each clothing, and 1 represents the length of the clothing.

As a result, the resonant frequency f that generates the standing wave in the clothing L is set differently depending on the length 1 of the clothing, and decreases as the length 1 of the clothing increases.

Referring to (c) in FIG. 17, the moving hanger 100 may operate at a frequency that is twice the minimum resonant frequency.

As a result, the operating speed of the driver 200 is doubled, so that the vibration period of the power transmitter 400 may be reduced by half. As a result, the clothing may vibrate while forming the standing wave with f2 corresponding to twice the first resonant frequency.

An operating speed of the driver 200 when the moving hanger 100 operates at the frequency that is twice (n=2) the minimum resonant frequency may be defined as a third speed.

That is, the clothing L may vibrate in a form of a second standing wave (n=2) in which two nodes n exist in the clothing L and three antinodes a exist.

When the clothing L vibrates in the second standing wave (n=2), locations where the nodes n and the antinodes a occur are different from the locations where the nodes n and the antinodes a occur when the clothing L vibrates in the first standing wave (n=1).

Therefore, when the frequency at which the moving hanger 100 operates is determined as the multiple of the resonant frequency, an area where a maximum amplitude occurs in the clothing may be controlled to vary.

Using the same, the clothing treating apparatus of the present disclosure may concentrate energy generated from the moving hanger 100 on a specific area of the clothing. In addition, the moving hanger 100 may intensively vibrate the specific area of the clothing while changing the specific area by changing the frequency. As a result, the clothing treating apparatus of the present disclosure may more strongly shake off dust or foreign substances on the clothing.

Referring to (d) in FIG. 17, the moving hanger 100 may operate at a frequency three times higher than the minimum resonant frequency.

An operating speed of the driver when the moving hanger 100 operates at the frequency three times higher than the minimum resonant frequency may be defined as a fourth speed.

The driver 200 may operate at a speed three times higher than the second speed, which is the speed when the clothing vibrates in the first standing wave, and the period of the power transmitter 400 may be shortened to ⅓.

As a result, the clothing may vibrate to form a third standing wave (n=3) while vibrating at a resonant frequency of f3, so that three nodes n may be formed and four antinodes a may be formed in the clothing L. When the clothing L vibrates at the third standing wave (n=3), locations where the nodes n and the antinodes a occur are all different from the locations where the nodes n and the antinodes a occur when the clothing L vibrates in the first standing wave (n=1) and when the clothing L vibrates in the second standing wave (n=2). In addition, a spacing between the node n and the node n may become narrower than that before.

In some examples, an amplitude of the antinode a may be the same as that when the moving hanger 100 operates at the minimum resonant frequency or at the resonant frequency twice higher than the minimum resonant frequency.

The clothing treating apparatus of the present disclosure may adjust the frequency of the moving hanger 100 to set an area where the clothing vibrates greater to evenly vibrate the clothing, or to set the area where the clothing vibrates smaller to intensively vibrate the clothing.

Referring to (e) in FIG. 17, when the moving hanger 100 operates at a frequency four times higher than the minimum resonant frequency and the driver 200 operates at a speed four times higher than the second speed when the clothing vibrates in the first standing wave, the reciprocal period of the power transmitter 400 is shortened to ¼.

An operating speed of the driver when the moving hanger 100 operates at the frequency four times higher than the minimum resonant frequency may be defined as a fifth speed.

In such manner, an operating speed of the driver 200 when the moving hanger 100 operates at k times (n=k) of the minimum resonant frequency may be defined as a k+1 speed.

As a result, the clothing vibrates with the resonant frequency of f4, and the clothing L vibrates in a fourth standing wave (n=4). The clothing L may vibrate with four the nodes n and the five antinodes a. When the clothing L vibrates in the fourth standing wave (n=4), locations where the nodes n and the antinode a occur are all different from the locations where the nodes n and the antinodes a occur when the clothing L vibrates in the first standing wave (n=1), when the clothing L vibrates in the second standing wave (n=2), and when the clothing L vibrates in the third standing wave (n=3).

In addition, the spacing between the node n and the node n may be narrower than that before. When the amplitude of the power transmitter 400 is uniform, the amplitude of the antinode a may also be uniform.

When the driver 200 operates faster, the spacing between the nodes n formed in the clothing may become narrower, and the locations where the nodes n are formed may also change.

As such, when the moving hanger 100 vibrates at n multiples of the minimum resonant frequency or when the driver 200 vibrates at n multiples of the second speed corresponding to the minimum resonant speed, the clothing L may vibrate in a form of a standing wave proportional to the n multiple.

Based on Equation (1), the resonant frequency at which the clothing vibrates in the standing wave is determined differently depending on the length of the clothing. In addition, the operating speed or the operating rpm of the driver 200 at which the clothing may vibrate in the standing wave may also be determined as a unique value of each clothing.

In one example, the clothing treating apparatus of the present disclosure may distinguish whether the clothing vibrates randomly or vibrates while forming the standing wave.

While the moving hanger 100 increases the operating frequency, when the corresponding operating frequency corresponds to the resonant frequency of the hung clothing, vibration characteristics of the clothing will be different from those when the clothing does not vibrate in the standing wave.

In other words, when the clothing does not vibrate in the standing wave, a vibration change is linear or a change amount of the vibration is predictable, but when the clothing vibrates in the standing wave, the vibration characteristics vary rapidly, unlike when the clothing vibrates with a previous frequency and when the clothing vibrates with a subsequent frequency.

Using the above, the controller C may sense that the corresponding frequency of the moving hanger 100 is the resonant frequency of the hung clothing via a rapid change in the current value or the power value output from or applied to the motor 210 of the driver 200.

For example, when the clothing vibrates at the resonant frequency, the current value or the power value sensed by the driver 200 may have a peak value momentarily.

Alternatively, when the clothing vibrates in the standing wave, the vibration may be more attenuated and a smaller amount of vibration may be transmitted to the moving hanger 100 than when the clothing does not vibrate in the standing wave. Accordingly, the controller C may sense that the corresponding frequency is the resonant frequency of the hung clothing via a rapid decrease in the load applied to the driver 200.

Alternatively, the controller C may sense whether the frequency of the moving hanger 100 corresponds to the resonant frequency of the clothing in the manner described in FIG. 15. The controller C may sense in real time whether the clothing vibrates at the resonant frequency by analyzing characteristics of a second harmonic in the electrical information including the current value or the power value of the driver 200. For example, the controller C may sense that the corresponding frequency of the moving hanger 100 is the resonant frequency of the hung clothing via occurrence of a singularity where at least one of a waveform, an amplitude, and a period of the second harmonic rapidly changes.

In addition, the controller C may sense whether the clothing vibrates at the resonant frequency by identifying the change in the operating speed of the driver 200 when the clothing vibrates at the resonant frequency. For example, the controller C may identify the resonant frequency of the clothing by sensing the temporary change in the operating speed of the driver 200 when the clothing vibrates at the resonant frequency and when the clothing vibrates at a frequency different from the resonant frequency.

In addition, the controller C may sense the resonant frequency via a temporary change in the inertial force transmitted to the moving hanger 100 when the clothing vibrates at the resonant frequency.

In addition, even when the clothing does not actually vibrate at the resonant frequency, the controller C may immediately estimate the resonant frequency of the corresponding clothing by matching the second harmonic wave output from the driver 200 when the corresponding clothing vibrates with a table or data stored in advance.

In addition, the controller C may identify whether the sensed resonant frequency corresponds to the actual resonant frequency. For example, when the moving hanger 100 operates at a frequency corresponding to a multiple of the resonant frequency sensed by the controller C, whether the change sensed in the above-described method appears periodically may be identified.

As a result, the controller C may calculate and sense one or more of the resonant frequency of the clothing, the operating speed of the driver 200 for vibrating the clothing at the resonant frequency, the RPM of the driver 200, and the reciprocal period of the power transmitter 400 via the moving hanger 100.

Hereinafter, an example of a control method in which the clothing treating apparatus of the present disclosure accurately senses a weight of clothing by using vibration characteristics of the clothing will be described.

In one example, when the clothing L vibrates and the node n is formed on the clothing, vibration occurring below the node n may not be fully transmitted to the moving hanger 100.

In addition, when the clothing L vibrates in the standing wave, because the location of the node n may be always fixed, the vibration occurring in the clothing L may be blocked by the node n and may not be completely transmitted to the moving hanger 100.

In addition, as the clothing L vibrates in a larger multiple of the standing wave L, the spacing between the node n and the node n becomes smaller, so that a total amount of vibration energy of the clothing remaining between the nodes becomes smaller. As a result, a location of a node closest to the moving hanger 100 also becomes closer to the moving hanger 100 as the clothing vibrates in the larger standing wave, so that less vibration or inertial force is transmitted to the moving hanger 100.

In summary, even when the weight of the clothing is the same, the vibration energy or the inertial force transmitted from the clothing L to the moving hanger 100 varies depending on the location where the node n occurs in the clothing L, the spacing between the moving hanger 100 and the adjacent node n, and whether the clothing L vibrates in the standing wave or in an arbitrary waveform. Therefore, for the clothing treating apparatus of the present disclosure to accurately and consistently calculate the weight of the clothing hung on the moving hanger 100, it may reduce or block the vibration generated in the clothing.

In some examples, the clothing treating apparatus of the present disclosure may calculate the weight of the clothing while operating the moving hanger 100 at the frequency lower than the resonant frequency at which the standing wave occurs in the clothing.

In addition, the clothing treating apparatus of the present disclosure may calculate the weight of the clothing while operating the moving hanger 100 at a frequency lower than the fundamental frequency (period) at which the waveform or the vibration begins to occur on the clothing.

That is, the clothing treating apparatus of the present disclosure may operate the driver 200 in a speed range equal to or lower than the speed at which the clothing vibrates in the standing wave when calculating the weight of the clothing hung on the moving hanger 100.

The clothing treating apparatus of the present disclosure may operate the driver 200 in a speed range equal to or lower than the second speed, which is the minimum resonant speed, to calculate the weight of the clothing.

Specifically, the controller C of the clothing treating apparatus of the present disclosure may sense the weight of the clothing via the electrical information applied to or output from the driver 200 while increasing the operating frequency of the moving hanger 100 in a range from a speed at which the moving hanger 100 stops to the second speed.

In addition, the controller C may sense the weight of the clothing by operating the driver 200 in a speed range equal to or lower than the first speed to minimize influence of the vibration of the clothing on the driver 200 and to exclude or reduce influence of the node n that occurs when the clothing vibrates while causing the diffraction.

That is, the controller C may operate the moving hanger 100 in a speed range lower than a speed at which the diffraction occurs in the clothing, thereby excluding or reducing the influence of the vibration of the clothing on the driver 200, and analyzing the load applied to the driver 200 to calculate the weight of the clothing.

In calculating the weight of the clothing by operating the driver 200, the controller C may directly borrow a scheme of using the motor to rotate the drum in the washing machine and dryer, and may also apply the method described in FIG. 15 as it is.

As a result, the clothing treating apparatus of the present disclosure may accurately sense the weight of the clothing. In addition, the clothing treating apparatus of the present disclosure may operate the machine room to supply the steam or the hot air to the clothing after sensing the weight of the clothing. That is, one or more of the steam and the hot air supplied to the clothing may be set differently depending on the sensed weight of the clothing, and the operating frequency of the moving hanger 100 may also be controlled differently.

For example, the clothing treating apparatus of the present disclosure may operate the moving hanger 100 at the frequency equal to or lower than the fundamental frequency when sensing the weight of the clothing, but may operate the moving hanger 100 at a frequency higher than the fundamental frequency when performing an arbitrary course for treating the clothing. Accordingly, the clothing treating apparatus of the present disclosure may transmit more physical force to the clothing when treating the clothing, thereby removing more foreign substances from the clothing or exposing the clothing to the supplied steam and hot air more evenly.

The clothing treating apparatus of the present disclosure may determine a maximum frequency for operating the moving hanger 100 differently depending on the weight of the clothing. The clothing treating apparatus of the present disclosure may control the maximum frequency for operating the moving hanger 100 to vary depending on the weight of the clothing when supplying at least one of the steam and the hot air to the inner casing 20.

For example, even when the moving hanger 100 operates at the same frequency, more vibrations may occur as the weight of the clothing increases. Accordingly, the maximum frequency for operating the moving hanger 100 may be set lower as the weight of the clothing increases.

For example, the heavier the clothing, the more hot air or steam may be supplied to the clothing to complete the drying, the deodorization, the sterilization, the dehumidification, and the like of the clothing. Therefore, the clothing treating apparatus of the present disclosure may control the steam supply 50 such that a spray amount of steam supplied to the inner casing is greater or a spray time of steam is greater when the clothing is sensed to be heavy than when the clothing is sensed to be light. In addition, the clothing treating apparatus of the present disclosure may control the compressor 83 and the blower fan such that a supply amount of hot air or a supply time of hot air is greater when the clothing is heavy than when the clothing is light.

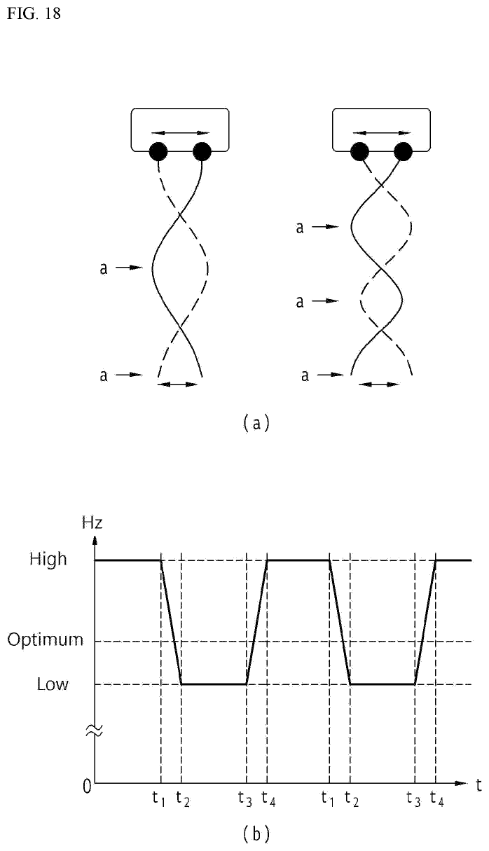

FIG. 18 shows an example of controlling a moving hanger using sensing of a weight and a resonant frequency of clothing by a clothing treating apparatus of the present disclosure.

The clothing treating apparatus of the present disclosure may determine an optimal frequency (Optimum Hz) that may optimally operate the moving hanger 100 based on the weight of the clothing. The optimal frequency (Optimum Hz) may be determined as a frequency at which an amount of vibration generated from the clothing is the smallest. In addition, the optimal frequency (Optimum Hz) may be determined as a frequency at which the clothing may maximally vibrate without exceeding a limit vibration level at which radiation of the vibration occurred from the clothing to the outside of the cabinet 10 is allowed.

Therefore, the clothing treating apparatus of the present disclosure may operate the moving hanger 100 at the optimal frequency (Optimum Hz), thereby applying sufficient physical force to the clothing while reducing the vibration generated from the clothing treating apparatus.

In one example, as described above, when the clothing operates at the resonant frequency, the clothing may vibrate while the antinode and the node are fixed, so that a specific area of the clothing may be concentrated, and the vibration or the inertial force transmitted from the clothing may be decreased.

Therefore, the clothing treating apparatus of the present disclosure may operate the moving hanger at the resonant frequency at which the clothing vibrates in the standing wave at least in some periods during the arbitrary course of treating the clothing.

That is, the clothing treating apparatus of the present disclosure may operate the moving hanger 100 at the optimal frequency (Optimum Hz) corresponding to the weight of the clothing, but may operate the moving hanger 100 at the resonant frequency such that the clothing may vibrate in the standing wave at least in some periods. As a result, while minimizing the vibration generated from the clothing, a concentrated physical force may be transmitted to the specific area of the clothing.

In addition, the clothing treating apparatus of the present disclosure may operate the moving hanger 100 at two or more resonant frequencies such that the clothing may vibrate in the form of two or more standing waves. As a result, the area where the clothing vibrates intensively may be changed, and the concentrated physical force may be sequentially applied to the entire clothing. Therefore, the effect of removing foreign substances from the clothing and the effect of exposing the clothing to steam and hot air may be increased.

In addition, the controller C may repeatedly operate the moving hanger 100 at the optimal frequency and the resonant frequency. As a result, while minimizing the vibration transmitted to the cabinet 10, the specific area of the clothing may intensively oscillate.

In addition, the controller C may operate the moving hanger 100 at the first resonant frequency at which the clothing vibrates in the standing wave for a first time period, and at the second resonant frequency at which the clothing vibrates in a different standing wave for a second time period. The controller C may completely omit operating at the optimal frequency.

The first time period and the second time period may be the same.

In addition, the first time period may be different from the second time period. For example, the first time period may be set smaller than the second time period.

In addition, the controller C may operate the moving hanger 100 at the first resonant frequency at which the clothing vibrates in the standing wave for the first time period, operate the moving hanger 100 at the second resonant frequency at which the clothing vibrates in the different standing wave for the second time period, and operate the moving hanger 100 at the optimal frequency for a third time period.

In this regard, the first resonant frequency may be an arbitrary frequency corresponding to n multiples of the minimum resonant frequency, as the frequency at which the clothing may operate at the resonant frequency.

In addition, the second resonant frequency may be an arbitrary frequency corresponding to n+1 multiples of the minimum resonant frequency as another frequency at which the clothing may operate at the resonant frequency.

Specifically, the controller C may determine the optimal frequency for operating the moving hanger based on the sensed weight of the clothing, and may operate the moving hanger 100 also at the resonant frequency close to the optimal frequency at least in some periods during the course execution.

That is, even when operating the moving hanger 100 at the resonant frequency, the controller C may operate the moving hanger 100 at the resonant frequency close to the optimal frequency, thereby maximally suppressing the vibration transmitted from the clothing and stably oscillating the clothing.

Referring to (a) in FIG. 18, as the operating frequency of the moving hanger 100 changes, the locations of the node n and the antinode a formed in the clothing L change.

The controller may operate the moving hanger 100 at a resonant frequency (High Hz) higher than the optimal frequency (Optimum Hz) and a resonant frequency (Low Hz) lower than the optimal frequency at least in some periods during the course execution.

The controller may repeat operating the moving hanger 100 at the resonant frequency (High Hz) higher than the optimal frequency (Optimum Hz) for a certain time period and then operating the moving hanger 100 at the resonant frequency (Low Hz) lower than the optimal frequency for a certain time period.

The controller C may operate the moving hanger 100 at the high resonant frequency (High Hz), then operate the same at the optimal frequency, and then operate the same at the low resonant frequency (Low Hz), and may repeat such process.

Referring to (b) in FIG. 18, when the moving hanger 100 operates at the resonant frequency (High Hz) higher than the optimal frequency, the clothing may vibrate as shown in a figure on the right. When the moving hanger 100 operates at the resonant frequency (Low Hz) lower than the optimal frequency, the clothing may vibrate as shown in a figure on the left.

Using the above, the controller C may repeat operating the driver 200 to vibrate the clothing in the left form for a certain time period, then increasing the operating speed of the driver 200 to vibrate the clothing in the right form for a certain time period, and then decreasing the operating speed of the driver 200 to vibrate the clothing in the left form.

As such, the controller C may vary the operating speed or the operating cycle of the moving hanger 100 to change the location of the antinode a formed in the clothing, thereby appropriately distributing the force of removing dust to the clothing. The controller C may change the locations of the node n and the antinode a formed in the clothing L and then fix the locations of the node n and the antinode a again to intensively remove foreign substances in other areas.

A time period during which the driver 200 operates at various multiples of the second speed may be set greater than a time period during which the driver 200 accelerates or decelerates.

(b) in FIG. 18 shows that the controller C accelerates and decelerates the moving hanger 100 at the two resonant frequencies, but this is only an implementation, and the controller C is able to operate the moving hanger 100 to accelerate and decelerate in a stepwise manner at three, four, or more resonant frequencies.

In one example, the controller C may actively utilize the fact that the vibration transmitted from the clothing is decreased when operating the moving hanger 100 at the resonant frequency.

For example, the controller C may operate the clothing at a frequency other than the resonant frequency, and when excessive vibration occurs in the clothing, may operate the moving hanger 100 at a frequency corresponding to the resonant frequency to suppress the vibration of the clothing L.

For example, the controller C may operate the clothing at the optimal frequency, and when excessive vibration occurs in the clothing, may operate the moving hanger 100 at a frequency corresponding to the resonant frequency to suppress the vibration of the clothing L.

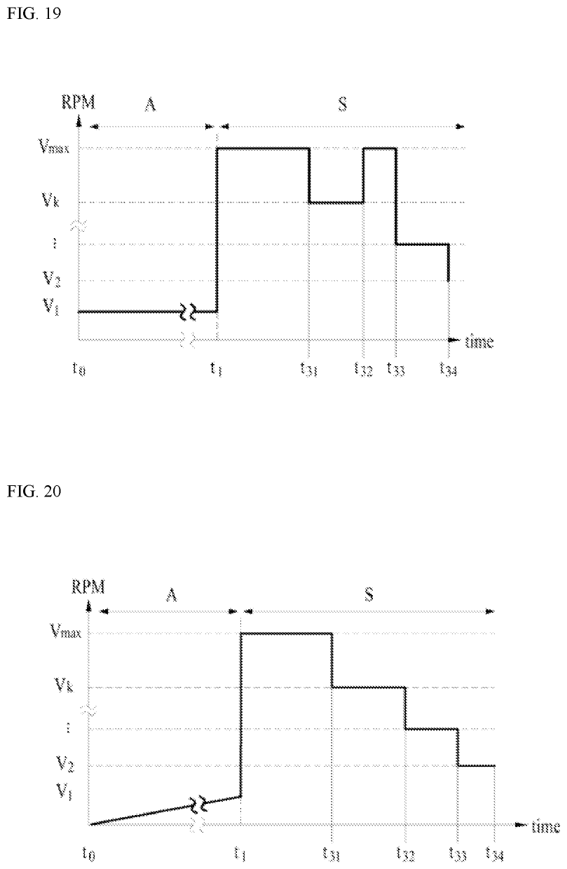

FIG. 19 shows a process in which a clothing treating apparatus of the present disclosure senses a weight of clothing via a moving hanger.

The clothing treating apparatus of the present disclosure may provide a control method including a sensing step A of sensing the clothing information and an operating step S of operating the machine room 30 to treat the clothing when a power command for supplying the power to the controller C is input via the input part I, an execution command for the controller C to perform the arbitrary course is input, or it is sensed that the door 11 has opened and then closed the accommodating space 21.

The sensing step A may include a weight sensing step A1 of sensing the weight of the clothing, and the weight sensing step A1 may include calculating the weight of the clothing via the electrical information applied to the moving hanger 100 or output from the moving hanger 100 while the controller C operates the moving hanger 100.

In the weight sensing step A1, the controller C may sense the weight of the clothing while operating the driver 200 at a first speed V1 for a first time period t1.

Among the operating speeds of the driver 200, the first speed V1 may be defined as a speed at which the diffraction does not occur in the clothing, and a second speed V2 may be defined as a minimum speed at which the clothing vibrates at the resonant frequency.

The first speed V1 may correspond to a minimum speed at which the diffraction may not occur in the clothing.

The controller C may sense the weight of the clothing by analyzing the electrical information of the driver 200 while operating the driver 200 at the first speed V1 constantly. Because the electrical information may exclude errors related to the vibration of the clothing L as much as possible, the controller C may accurately calculate the weight of the clothing via only the operation of the moving hanger 100.

The sensing step A may include an acceleration step A2 capable of sensing the resonant frequency of the clothing.

In the acceleration step A2, the controller C may operate the moving hanger 100 at the speed equal to or higher than the second speed to sense that the clothing vibrates in the standing wave. Because the second speed is the initial speed at which the clothing vibrates in the standing wave, the acceleration step A2 may be viewed as a step in which the controller C senses the second speed, and may be viewed as a step of sensing the minimum speed of the driver 200 at which the clothing operates in the standing wave.

In the acceleration step A2, the controller C may sense and identify the resonant frequency of the clothing while increasing the operating speed of the driver 200 by a multiple of the second speed.

In one example, in the operating step S, the controller C may operate the driver 200 at a speed higher than the first speed and the second speed. Therefore, the sensing step A may correspond to a step of operating the moving hanger 100 for a certain time period at a speed lower than that in the operating step S.

In addition, because the operating step S is performed by utilizing the information sensed in the sensing step A, the controller C may set one or more of the operating speed, an operating cycle, the operating frequency, and the operating RPM of the moving hanger 100 operating in the operating step S differently based on the clothing information sensed in the sensing step A.

For example, in the operating step S, the driver 200 may be accelerated or decelerated in a stepwise manner in an area corresponding to a multiple of the resonant frequency f, and the acceleration and the deceleration may be repeated.

For example, in the operating step S, the controller C may operate the driver 200 at the maximum speed and then operate the driver 200 by decreasing the operating speed of the driver 200 to a K+1 speed that generates a Kth standing wave in the clothing. The k may be an arbitrary natural number. That is, the controller C may arbitrarily change the k value to operate the clothing L at various resonant frequencies.

For example, the controller C may increase the operating speed of the driver 200 again to operate the driver 200 at the maximum speed, then operate the driver 200 by decreasing the operating speed of the driver 200 to the third speed that generates the second standing wave, and then operate the driver 200 by decreasing the operating speed of the driver 200 to the second speed that generates the first standing wave in the clothing.

FIG. 20 shows another example of a process in which a clothing treating apparatus of the present disclosure senses a weight of clothing via a moving hanger.

The first speed is a speed at which the diffraction does not occur in the clothing, but is set differently depending on the material or the length of the clothing. Therefore, the controller C may have difficulty in identifying whether the speed of the driver 200 set in the weight sensing step A1 corresponds to the first speed of the corresponding clothing.

Therefore, the clothing treating apparatus of the present disclosure may sense a period corresponding to the first speed by gradually accelerating the driver 200 from the stationary state when the weight sensing step A1 is performed.

The controller C may operate the driver 200 to accelerate from the stationary state to the speed at which the diffraction occurs in the clothing or the speed at which the clothing vibrates while forming the standing wave.

When sensing that the diffraction occurs in the clothing or that the clothing vibrates in the standing wave while increasing the operating speed of the driver 200, the controller C may define a speed prior to the sensing as the first speed.

Furthermore, the controller C may increase the operating speed of the driver 200 until it senses that the diffraction occurs in the clothing or the clothing vibrates in the standing wave, and then store the corresponding speed. In some examples, the controller C may decrease and then increase the operating speed of the driver 200 again to identify whether the stored corresponding speed is a speed at which the diffraction occurs in the clothing or the clothing vibrates in the standing wave.

Via such process, the controller C may identify not only the first speed but also the second speed, and may calculate the weight of the clothing by analyzing the electrical information of the driver 200 when accelerating the driver 200 to the first speed.

Alternatively, the controller C may re-operate the moving hanger 100 at a speed equal to or lower than the first speed V1 and analyze the electrical information of the driver 200 to calculate the weight of the clothing.

In addition, the controller C may increase the operating speed of the driver 200 to the second speed V2 or higher in the acceleration step A2 to check whether the second speed V2 is the minimum resonant speed that allows the clothing to vibrate in the standing wave.

For example, the controller C may also sense the resonant frequency of the clothing by checking whether the clothing L vibrates in a (k−1)th standing wave at the second speed V2 and a speed Vk corresponding to a k multiple of the second speed in the acceleration step A2. k may correspond to an arbitrary natural number.

When the operating step S is performed after the sensing step A, the controller C may accelerate the driver 200 to the maximum speed Vmax and oscillate the clothing, and then decelerate or accelerate the driver 200 to a speed section corresponding to a multiple of the second speed to intensively oscillate the specific area of the clothing in a stepwise manner.

To prevent overload of the driver 200, in the operating step S, the operating speed of the driver 200 may be decreased in a stepwise manner in periods corresponding to multiples of the second speed, such as a third speed, a fourth speed, and an nth speed.

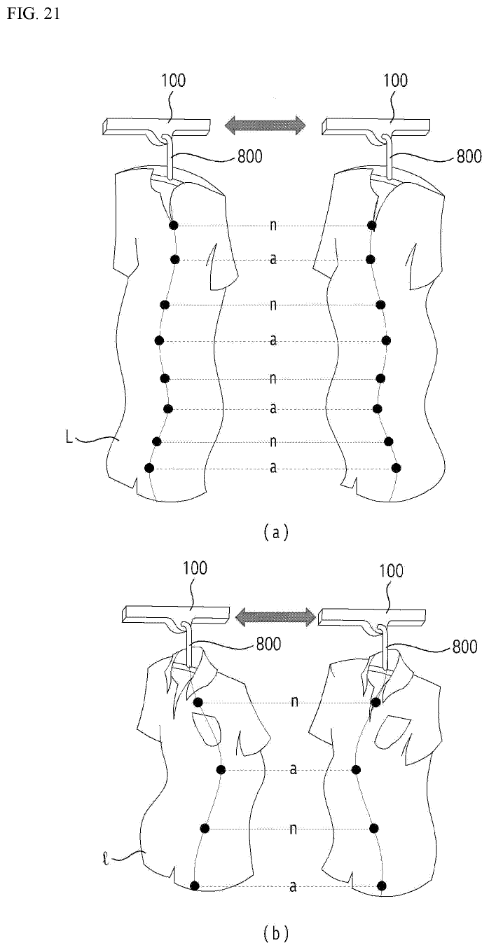

FIG. 21 shows a principle by which a clothing treating apparatus of the present disclosure is able to sense a length of clothing.

(a) in FIG. 21 shows that the driver 200 operates at a specific speed higher than the second speed V2 in a state in which the long clothing L is hung on the moving hanger 100, and (b) in FIG. 21 shows that the driver 200 operates at the specific speed the same as that when the long clothing L is hung on the moving hanger 100, in a state in which the clothing L shorter than the long clothing L is hung on the moving hanger 100.

According to Equation (1), because the resonant frequency is inversely proportional to the length of the clothing, the short clothing L will have a resonant frequency greater than that of the long clothing L, and the moving hanger 100 may operate at a higher speed to form a standing wave of the same order in the short clothing L.

Referring to (a) in FIG. 21, the specific speed may correspond to a speed four times higher than the second speed or the minimum resonant speed based on the long clothing L. Therefore, the long clothing L may vibrate while forming the fourth standing wave.

Referring to (b) in FIG. 21, even when the short clothing L is hung, the driver 200 may operate at the same speed. In other words, also in (b) in FIG. 21, the driver 200 may operate at the operating speed that may form the fourth standing wave in the long clothing L.

In the case of the short clothing L, the operating speed may correspond to an operating speed that forms a second standing wave in the short clothing. That is, because the short clothing L has a length smaller than that of the long clothing L, the short clothing L has a resonant frequency different from that of the long clothing L.

The clothing treating apparatus of the present disclosure may also sense the length of the clothing by operating the moving hanger 100 by utilizing the property that the clothing has different resonant frequencies depending on the length thereof.

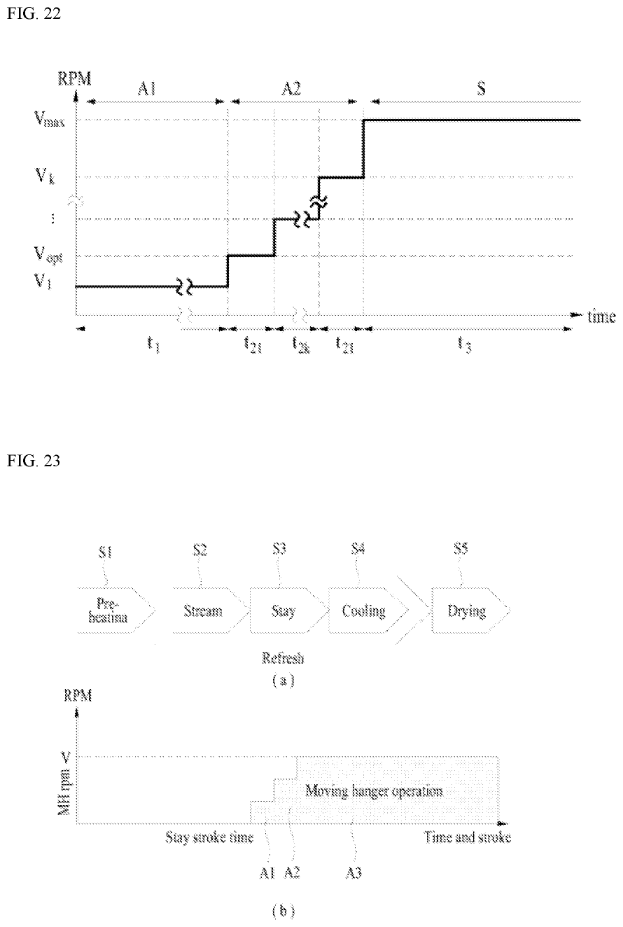

FIG. 22 shows an example in which a clothing treating apparatus of the present disclosure senses not only a weight of clothing but also a length thereof.

The control method of the clothing treating apparatus of the present disclosure may include a length sensing step A2 of also sensing the length of the clothing in the sensing step A. That is, the acceleration step A2 may be viewed as including the length sensing step A2.

$${f}_{n} = \frac{v}{{λ}_{n}} = \frac{v}{2 l} n ( n = 1 , 2 , 3 … ) \qquad ( 1 )$$

Referring to Equation (1), a resonant frequency fn at which the clothing vibrates in the standing wave is inversely proportional to the length of the clothing. In some examples, even when the resonant frequency fn is known, there may be a limitation in that the length 1 of the clothing is not able to be accurately sensed when the v value of Equation (1) is not known.

$$v = \sqrt{\frac{T}{μ}} = \sqrt{\frac{mg}{μ}} \qquad ( 2 )$$

Referring to the equation (2), the v is equal to a square root of a tension T of the clothing divided by a linear density m thereof, and the tension of the clothing corresponds to the weight of the clothing.

Because the linear density m corresponds to a constant value when the clothing is the same, the controller C may identify the length 1 of the clothing when sensing the weight and the resonant frequency fn of the clothing.

In some examples, the controller C may directly calculate the weight of the clothing via the electrical information of the driver 200 in the weight sensing step A1, and may calculate the length of the clothing with the weight and the resonant frequency of the clothing by sensing one or more resonant frequencies at which the clothing may vibrate in the standing wave while changing the operating speed of the driver 200 in the length sensing step A2.

When the controller C is not able to specifically sense or calculate the linear density m, the controller C may sense two or more resonant frequencies at which the clothing may vibrate in the standing wave, and calculate the length 1 of the clothing using the sensed resonant frequencies.

In addition, the controller C may sense the resonant frequency at which the clothing may vibrate in the standing wave via the moving hanger 100, and calculate the length 1 of the clothing via the electrical information output from the driver 200 when changing the operating frequency of the moving hanger 100.

As a result, the controller C may calculate the weight of the clothing by operating the driver 200 in a speed range lower than the second speed V2 at which the clothing may initially vibrate at the resonant frequency, and may calculate the length of the clothing by operating the driver 200 in a speed range equal to or higher than the second speed at which the clothing may initially vibrate at the resonant frequency.

The speed range lower than the second speed may include the first speed, and in the operating period s, the driver 200 may operate at a speed higher than the second speed.

Referring to FIG. 22, the controller C may perform the sensing step A of sensing the clothing information.

The controller C may perform the weight sensing step A1 of calculating the weight of the clothing via the electrical information including the current applied to or output from the driver 200, while operating the driver 200 at the first speed V1 during the first time period t1 in the sensing step A.

When the weight sensing step A1 is completed, the controller C may perform the length sensing step A2 of sensing the length of the clothing in the sensing step A.

The length sensing step A2 may be performed in a speed range higher than that in the weight sensing step A1, and may be performed in a speed range including the second speed or resonant speed V2 that generates the initial resonant frequency.

In addition, the length sensing step A2 may be performed during the second time period t2, and because the length of the clothing is calculated while operating the driver 200 at the resonant speed v2 and the speed higher than the resonant speed v2, the second time period t2 may be set greater than the first time period t1.

In one example, the controller C may obtain information for calculating the length 1 of the clothing while increasing the speed of the driver 200 in a stepwise manner during the second time period.

For example, the controller C may sense the minimum resonant frequency by operating the moving hanger 100 at the second speed or the resonant speed, which is the minimum operating speed at which the clothing vibrates in the standing wave, during a second-first time period t21.

In addition, the controller C may further accelerate the driver 200 until the clothing vibrates in the standing wave, and when the clothing vibrates in the standing wave again, the moving hanger 100 may be operated for a second-second time period t22 to sense another resonant frequency. During the second-second time period t22, the moving hanger 100 will be operated at a speed that is twice the second speed.

The controller C may further accelerate the driver 200 until the clothing vibrates in the standing wave again, and may repeat such process k times. When the clothing vibrates in the standing wave again, the resonant frequency of the clothing may be sensed while operating the moving hanger 100 at a speed that is k multiples of the second speed for a second-kth time period.

As a result, the controller C may increase the operating speed of the driver 200 up to a period where the clothing operates at the resonant frequency, and when the clothing operates at the resonant frequency, may maintain the operating speed of the driver 200 and store the electrical information of the driver 200. When the electrical information of the driver 200 is obtained in various resonant speed ranges, the controller C may calculate the length of the clothing via at least one of the electrical information and the weight of the clothing.

When at least one of the length of the clothing and the weight of the clothing is sensed, the controller C may perform the operating step S by optimizing the same based on the clothing information.

In the operating step S, the moving hanger 100 may be operated for the third time period t3, and the third time period may be set greater than the first time period t1 and the second time period t2.

In the operating step S, the moving hanger 100 may be operated at a speed higher than the speed at which the moving hanger 100 was operated in the sensing step A.

For example, in the operating step S, the moving hanger 100 may be operated at the maximum speed Vmax or may be operated in a speed range including the second speed but higher than the second speed, and the operating speed may vary linearly or in a stepwise manner in the speed range higher than the second speed.

FIG. 23 shows an example of a method for controlling a clothing treating apparatus of the present disclosure.

The method for controlling the clothing treating apparatus of the present disclosure may include the sensing step A of sensing the clothing information and the operating step S of treating the clothing.

The sensing step A and the operating step S may be performed sequentially, but the sensing step A may be performed during the execution of the operating step S. That is, because the moving hanger 100 may not be always operated in the operating step S, the sensing step A may be performed at any time before the moving hanger 100 is operated in the operating step S.

The clothing treating apparatus of the present disclosure may perform the operating step S when a command to perform an arbitrary course is input via the input part I.

The operating step S may include a heating step S1 of operating the steam supply 50 to heat water contained in the steam generator 51, a steam step S2 of supplying steam to the accommodating space 21 when water boils and steam is generated in the steam generator 51, a waiting step S3 of stopping the operation of the steam generator 51 when the steam is sprayed in a set amount or for a set time period, a cooling step S4 of cooling air in the accommodating space 21 while cooling the clothing by operating only the blower fan to improve an efficiency (COP) of the heat pump system, and a drying step S5 of supplying hot air to the accommodating space 21 by operating the compressor 83 and the blower fan.

In some implementations, an optimal operating speed of the driver 200 is determined based on the clothing information sensed in the sensing step A.

In some implementations, the rpm and the operating time of the compressor, and the operating time and the rpm of the blower fan are determined based on the clothing information sensed in the sensing step A.

In some implementations, the sensing step A is performed before the drying step S5.

In addition, when the moving hanger 100 is operated, when the clothing is removed from the hanger 700 and falls, there is a concern that the steam may be sprayed to be concentrated only on a specific area of the clothing and the clothing may be damaged. Therefore, the moving hanger 100 may be operated from the waiting step. In some implementations, after the steam step S2, the moving hanger 100 is operated such that foreign substances, dust, and moisture attached to the clothing may be removed.

Therefore, because the sensing step A is a step of sensing the clothing information including the weight and the length of the clothing while operating the moving hanger 100, the sensing step A may be performed after the steam step S2 and before the drying step s5.

In some implementations, the driver 200 of the moving hanger 100 operates faster in the operating step S than in the sensing step. Therefore, the driver 200 may operate faster in the drying step S5 than in the sensing step A.

When a speed of the driver 200 of treating the clothing in the operating step S is referred to as a treating speed, the treating speed may be set to be higher than at least one of the first speed and the second speed at which the driver 200 is operated in the sensing step A. The treating speed may be the same as the second speed.

In addition, the sensing step A may be performed while the waiting step S3 and the cooling step S4 are in progress. Therefore, the driver 200 may start operating at the first speed from the waiting step S3 or the cooling step S4.

In the sensing step A, the weight sensing step A1 may be performed first and then the length sensing step A2 may be performed.

Therefore, in the weight sensing step A1, the speed at which the driver 200 or the clothing vibrates may be lower than the speed at which the driver 200 or the clothing vibrates in the length sensing step A2.

In the weight sensing step A1, the driver 200 may be operated in a speed range equal to or lower than the first speed.

The length sensing step A2 may be performed in a speed range equal to or higher than the second speed, which is a speed range higher than that in the weight sensing step A1.

The weight sensing step A1 and the length sensing step A2 may be performed continuously.

In the sensing step A, the controller C may operate the moving hanger at two or more speeds. The moving hanger 100 may be operated at a time point after the steam supply 50 is operated.

Because of the sensing step A, the controller C may operate the moving hanger 100 in a speed range before the clothing starts to oscillate at the resonant frequency or in the standing wave and in a speed range equal to or higher than the speed at which the clothing starts to oscillate at the resonant frequency or in the standing wave.

In addition, because of the length sensing step A2 in the sensing step A, the controller C may operate the driver 200 in at least two speed ranges higher than the second speed.

Because of the weight sensing step A1, the controller C may sense the weight of the clothing by operating the moving hanger in a speed range equal to or lower than the speed at which the clothing starts to oscillate in the standing wave.

Because of the length sensing step A2, the controller C may sense the length of the clothing by operating the moving hanger in a speed range equal to or higher than the speed at which the clothing starts to oscillate in the standing wave.

Because of the length sensing step A2, the controller C may sense the length of the clothing by operating the moving hanger such that the standing wave or the resonant frequency of the clothing changes.

In the sensing step A, the operating speed of the driver 200 at which the clothing oscillates at the resonant frequency may also be sensed, so that after the sensing step A, the controller C may operate the moving hanger 100 in a speed range corresponding to the resonant speed or the second speed, or a multiple of the second speed.

As a result, the controller C may operate the driver 200 in two or more speed ranges after operating the steam supply 50.

When the sensing step A is completed, the controller C may operate the compressor 83, the blower fan, and the driver 200 at the operating speed tailored to the clothing information in the operating step after the sensing step A.

In the sensing step A, the speed at which the driver 200 operates may be set lower than the speed at which the driver 200 operates in the operating step S.

Because of the sensing step A, the controller C may set the treating speed differently when at least one of the weight and the length of the clothing changes.

For example, when the clothing is heavy, the controller C may set the treating speed to the multiple of the resonant speed. As a result, the standing wave may be generated in the clothing to minimize the vibration energy generated from the clothing.

When the clothing is heavy, the controller C may set the treating speed to a lower value than that when the clothing is light. As a result, the vibration energy generated from the clothing may be decreased.

When the length of the clothing increases, the controller C may set the treating speed to the multiple of the resonant speed, compared to when the clothing is short. As a result, the dust removing force may be evenly distributed throughout the clothing.

The controller C may set the treating speed to be lower when the clothing is long than when the clothing is short. As a result, the vibration energy generated from the clothing may be decreased.

In addition, the controller C may control the machine room such that the supply amount of hot air or the supply time of the hot air is greater when the clothing is heavy than when the clothing is light. As a result, even when the clothing is heavy, the refreshing effect of the sterilization, the deodorization, the drying, and the wrinkle removal may be guaranteed.

In addition, the controller C may control the machine room such that the supply amount of hot air or the supply time of hot air is greater when the clothing is long than when the clothing is short. As a result, hot air may be evenly supplied to the long clothing, so that the refreshing effect of the sterilization, the deodorization, the drying, and the wrinkle removal may be guaranteed.

In the sensing step A, when the clothing is sensed as heavy, a duration of the operating step may be set greater than when the clothing is sensed as light. Therefore, a time period during which hot air and steam are more evenly supplied to the entirety of heavy clothing may increase, thereby ensuring the refreshing effect.

In the operating step S, when the clothing is sensed as heavy in the sensing step A, the operating time of the compressor or the operating rpm of the compressor may be set to be greater than when the clothing is sensed as light. As a result, hot air may be supplied more sufficiently to the entirety of heavy clothing, thereby ensuring the refreshing effect.

In the operating step S, when the clothing is sensed as long in the sensing step A, the operating speed range may be increased compared to when the clothing is sensed as short.

Because the operation of the compressor 83 is performed after the sensing step A in the operating step S, it may be seen that the controller C operates the driver 200 at the speed at which the clothing oscillates at the resonant frequency or in the standing wave when at least one of steam and hot air is supplied to the inner casing.

In addition, because the treating speed is determined by the resonant frequency or the like sensed in the sensing step A, the controller C may operate the moving hanger 100 such that the clothing oscillates at n multiples of the resonant frequency or in n multiples of the standing wave when at least one of steam and hot air is supplied to the inner casing.

Because the operation of the compressor 83 in the operating step S is performed after the sensing step A, it may be seen that the sensing step A operates the moving hanger 100, but blocks operation of at least one of the steam generator 51 and the compressor 83.

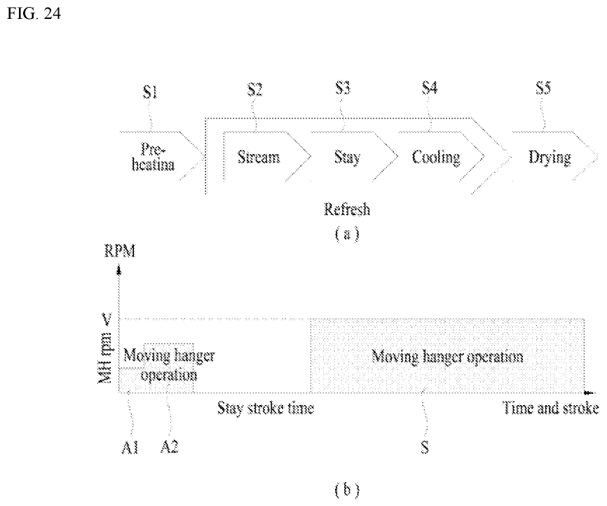

FIG. 24 shows another example of a method for controlling a clothing treating apparatus of the present disclosure.

Hereinafter, a description will be centered on parts different from those in the example in FIG. 23, and the same parts will be omitted to prevent redundant description.

The amount of steam supplied to the clothing and the duration of the steam supply may vary depending on the length and the weight of the clothing.

Therefore, the sensing step A may be performed before the steam step S2.

The sensing step A may be performed in the heating step S1. The heating step S1, as a step in which the heater inside the steam generator 51 is operated to heat water, but steam is not yet generated inside the steam generator 51, is a step of preparing the operating step S.

Therefore, the sensing step A may be performed to overlap at least a partial period of the heating step S1, thereby preventing a delay in a drying cycle.

In addition, because the steam step S2 may be performed based on the information such as the weight, the length, the material, and the like of the clothing sensed in the sensing step A, the steam step S2 may supply an appropriate amount of steam to the hung clothing.

Therefore, the controller C may control the machine room 30 such that the spray amount of steam or the spray time of steam is greater when the clothing is heavy than when the clothing is light. In other words, the operating time or the operating output of the heater in the steam generator 51 may be set to be greater. As a result, steam may be evenly supplied to the entire heavy clothing, thereby increasing the refreshing effect.

The controller C may control the machine room 30 such that the spray amount of steam or the spray time of steam is greater when the clothing is long than when the clothing is short. In other words, the operating time or the operating output of the heater in the steam generator 51 may be set to be greater. As a result, steam may be evenly supplied to the entire clothing, thereby increasing the refreshing effect.

As a result, in the operating step S, when the clothing is sensed as heavy in the sensing step A, the operating time of the steam generator 51 may be set greater than when the clothing is sensed as light.

In addition, in the operating step S, when the clothing is sensed as long in the sensing step A, the operating time of the steam generator 51 may be set greater than when the clothing is sensed as short.

In one example, also in this case, the operation of the moving hanger 100 may be stopped in the steam step S2. In some examples, for the steam to be evenly sprayed onto the clothing in the steam step S2, the moving hanger 100 may be operated.

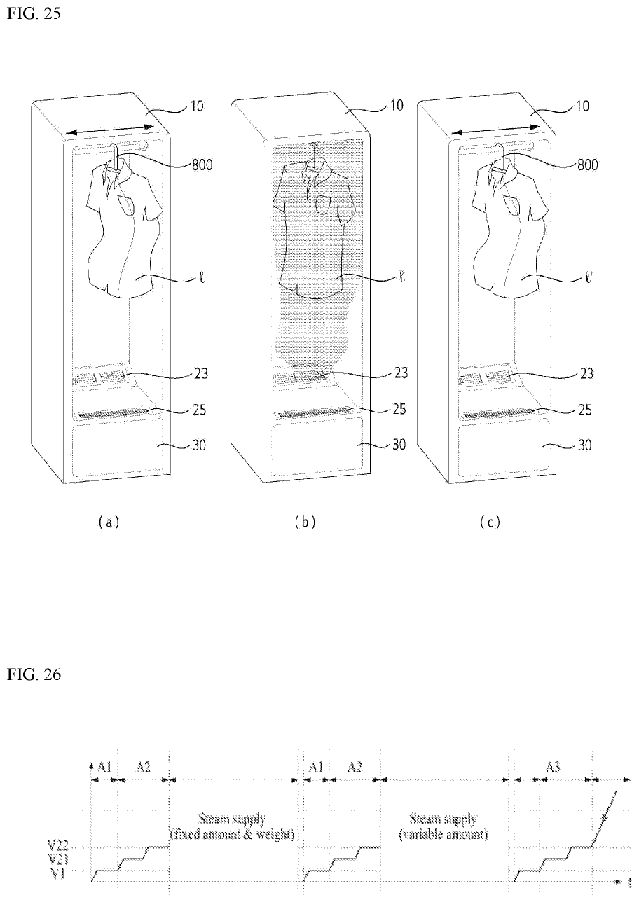

FIG. 25 shows an example in which a clothing treating apparatus of the present disclosure senses a material and also a moisture content.

The clothing treating apparatus of the present disclosure may calculate at least one of the material and the moisture content of the clothing by operating the moving hanger 100 in at least one of following cases: before the steam supply 50 operates; and after the steam supply 50 operates.

The clothing treating apparatus of the present disclosure may sense at least one of the material and the moisture content of the clothing in the sensing step A.

That is, the clothing treating apparatus of the present disclosure may further include a material sensing step A3 of sensing the material and the moisture content of the clothing in the sensing step A.

The material of the clothing may include the linear density m of the clothing. Therefore, the clothing treating apparatus of the present disclosure may sense whether the clothing is soft or hard.

The moisture content may include whether the clothing is hydrophilic or hydrophobic. Therefore, the clothing treating apparatus of the present disclosure may sense whether the clothing is hydrophilic or hydrophobic.

The controller C, the machine room 30, and the moving hanger 100 may perform a role of a sensor that senses the clothing information.

It may be seen that the clothing treating apparatus of the present disclosure includes the sensor that may sense the clothing information, and the sensor includes the controller C, the machine room 30, and the moving hanger 100.

The controller C may sense a change in the state of the clothing when operating at least one of the moving hanger 100 and the steam supply 50 and calculate the material and the moisture content of the clothing. For example, a state of the clothing before supplying steam to the clothing and a state of the clothing after supplying steam to the clothing may be sensed and then the change in the state of the clothing may be sensed to calculate at least one of the material and the moisture content of the clothing.

Referring to (a) in FIG. 25, the clothing treating apparatus of the present disclosure may perform at least one of the weight sensing step A1 and the length sensing step A2 by operating the moving hanger 100 before the material sensing step A3.

Referring to (b) in FIG. 25, the clothing treating apparatus of the present disclosure may supply a certain amount of steam to the clothing for a certain time period by operating the steam supply 50 in the sensing step A.

The purpose of operating the steam supply 50 in the sensing step A is not to supply steam to the clothing, but to induce the state change of the clothing. Therefore, a time period for operating the steam supply 50 in the sensing step A may be set smaller than a time period for operating the steam supply 50 in the operating step S.

Referring to (c) in FIG. 25, the clothing treating apparatus of the present disclosure may further perform at least one of the weight sensing step A1 and the length sensing step A2 after stopping the operating of the steam supply 50. Accordingly, the controller C may calculate one or more of the material and the moisture content of the clothing.

For example, the controller C may sense one or more of the material and the moisture content of the clothing by sensing a change in the weight of the clothing based on the supply of the steam. The greater the change in the weight of the clothing, the clothing may be determined to be more hydrophilic, and the smaller the change in the weight of the clothing, the clothing may be determined to be more hydrophobic.

In addition, the controller C may sense the material of the clothing by utilizing the fact that a degree to which the clothing absorbs steam varies depending on the material of the clothing. For example, in the sensing step A, an amount of steam supplied to the clothing with the steam supply 50 may be set to a fixed amount, and the change in the weight of the clothing depending on the material of the clothing may be generated as data and stored in advance in the controller C. Therefore, the controller C may sense the material of the clothing via the data. Accordingly, the controller C may also determine whether the clothing is hydrophobic or hydrophilic, whether the clothing is hard or soft, and the like.

The controller C may sense the material of the clothing by considering a change in the length sensing step A2 before and after the operation of the steam supply 50.

$${f}_{n} = \frac{v}{{λ}_{n}} = \frac{v}{2 l} n ( n = 1 , 2 , 3 … ) \qquad ( 1 )$$

$$v = \sqrt{\frac{T}{μ}} = \sqrt{\frac{mg}{μ}} \qquad ( 2 )$$

In the length sensing step A2, the controller C may sense the resonant frequency of the clothing via Equation (1).

In this regard, the V may include a weight mg of the clothing and the linear density m of the clothing, and one of the weight mg of the clothing and the linear density m of the clothing may be changed by the supply of steam. In some examples, the length of the clothing may be fixed before and after the supply of the steam.

Therefore, the controller C may sense at least one of the material and the moisture content of the clothing via at least one of a change in the resonant frequency of the clothing, a change in the weight of the clothing, and a change in the linear density of the clothing before and after the supply of the steam.

In one example, because the material of the clothing may usually be estimated via the linear density m, the linear density m of the clothing may be calculated by considering the change in the resonant frequency of the clothing and the change in the weight of the clothing before and after the supply of the steam. Accordingly, the controller C may analyze the linear density of the clothing to analyze whether the clothing is hard or soft, whether the clothing is hydrophilic or hydrophobic, and the like.

As a result, the clothing treating apparatus of the present disclosure may sense the weight of the clothing and the length of the clothing in the sensing step A, and may sense the weight of the clothing and the length of the clothing again after supplying steam. In this process, considering that the length of the clothing does not change, the material of the clothing may be sensed.

FIG. 26 shows an example of sensing clothing information including a material of clothing via the sensing step.

The clothing treating apparatus of the present disclosure may, when the sensing step A is performed, perform the weight sensing step A1 of sensing the weight of the clothing by operating the driver 200 at the first speed V1, and the length sensing step A2 of sensing the length of the clothing by operating the driver 200 in a stepwise manner at the speed equal to or higher than the second speed V2.

The length sensing step A2 may include operating the driver 200 at two or more speed ranges among a minimum resonant speed V21, a second resonant speed V22 that is twice the minimum resonant speed, and a Kth resonant speed V2K that is K times the minimum resonant speed.

The controller C may supply steam to the clothing after storing the sensed weight and length of the clothing. The supply amount of steam may be fixed to a reference amount.

A duration of the length sensing step A2 may be set greater than a duration of the weight sensing step A1. As a result, a sufficient time may be secured for the operating speed of the driver 200 to vary in various periods.

A time period during which the steam is supplied may be set greater than that in the length sensing step A2. As a result, a sufficient time may be secured for the steam to be generated in the steam supply 50 and for the clothing to be exposed to the steam.

In one example, when the steam is supplied, the controller C may perform the material sensing step A3.

The material sensing step A3 may include re-performing the weight sensing step A1 and the length sensing step A2 after the steam is supplied. The controller C may also determine whether the clothing is hydrophilic or hydrophobic via the weight change of the clothing in the weight sensing step A1. The controller C may also determine whether the clothing is hard or soft by determining the linear density m of the clothing in the length sensing step A2. The material sensing step A3 may be illustrated based on re-performing the weight sensing step A1 and the length sensing step A2 after the steam supply, but because the supplying of the steam may be performed for the material sensing, the material sensing step A3 may further include a steam supply step.

The sensing step A may stop the operation of the moving hanger 100 when the steam supply 50 operates.

In one example, the controller C may also calculate the type of clothing via the clothing information obtained in the weight sensing step A1, the length sensing step A2, and the material sensing step A3.

For example, the type of clothing corresponding to the clothing information may be generated as data and stored in the controller C. Accordingly, the controller C may determine the material and the type of clothing, such as “a one-piece dress made of a cotton material” or “a scarf made of a cashmere material”, via the weight, the length, and the material of the clothing.

In one example, the clothing treating apparatus of the present disclosure may perform a re-supply step of re-supplying the steam to the clothing after the material sensing step A3. The re-supply step includes operating the steam supply 50. At this time, unlike when steam was supplied before, steam may be supplied with a variable amount.

The controller C may determine whether the clothing is hydrophilic or hydrophobic in the material sensing step A3, and the controller C may vary the supply amount of steam in the re-supply step based on the material of the clothing.

For example, when the clothing is sensed as hydrophilic in the material sensing step A3, the supply amount of steam may be increased in the re-supply step. Further, when the clothing is sensed as hydrophobic in the material sensing step A3, the supply amount of steam may rather be increased in the re-supply step.

Thereafter, the controller C may re-perform the material sensing step A3 of the clothing. This allows checking whether the material of the clothing is the same as that sensed in the previous material sensing step A3.

For example, when the clothing is sensed as hydrophilic in a primary material sensing step A3, and the supply amount of steam is increased in the re-supply step, it may be confirmed that the clothing is hydrophilic when the weight of the clothing increases in a secondary material sensing step A3.

In some examples, when the clothing is sensed as hydrophobic in the primary material sensing step A3, but the supply amount of steam is increased in the re-supply step, it may be determined that the clothing may not be hydrophobic when the weight of the clothing increases in the secondary material sensing step A3.

As a result, the clothing treating apparatus of the present disclosure may perform the material sensing step A3 a plurality of times, and may confirm whether the sensed material of the clothing is correct by spraying steam to the clothing with the variable amount between the material sensing steps A3.

In other words, the controller C may operate the steam supply 50 and then operate the moving hanger 100, and then operate the steam supply 50 again and then operate the moving hanger 100 again to calculate the clothing information.

Accordingly, the controller C may operate the steam supply 50 and then operate the moving hanger to calculate the clothing information, and then operate the steam supply 50 and then operate the moving hanger again to verify the calculated clothing information.

An amount of steam supplied to the accommodating space 21 when the steam supply 50 is initially operated and an amount of steam supplied to the accommodating space 21 when the steam supply 50 is operated later may be set differently.

In one example, when the moving hanger 100 is operated in the sensing step A, the steam supply may be stopped. In some cases, when the steam supply 50 is operated, the operation of the moving hanger 100 may be stopped. As a result, the clothing may be prevented from being removed from the moving hanger 100 and blocking steam supplied from the steam supply 50, and a degree of steam being absorbed into the clothing may also be prevented from being varied.

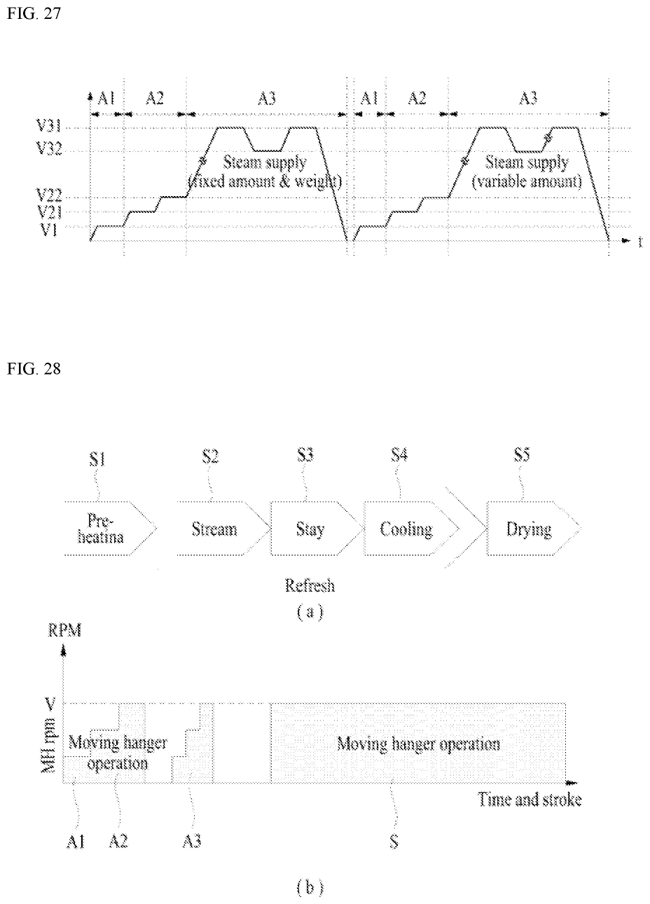

FIG. 27 shows another example of sensing a material of clothing.

As described above, the sensing step A may include the weight sensing step A1 and the length sensing step A2.

In some examples, the material sensing step A3 may be set as a step of operating the steam supply 50 and the moving hanger 100 simultaneously.

That is, the material sensing step A3 may include calculating the material of the clothing by operating the moving hanger 100 while operating the steam supply 50 to sense the changes in the weight of the clothing, the length of the clothing, and the resonant frequency of the clothing.

Therefore, it may be seen that, in the sensing step A, the steam supply 50 and the moving hanger 100 may be operable simultaneously.

When operating the steam supply 50, the operating speed of the driver 200 may vary. Accordingly, the controller C may obtain various data based on the operating speed of the driver 200, thereby accurately calculating the material of the clothing.

The material sensing step A3 may be performed a plurality of times, and the supply amount of steam may vary each time steam is supplied in the material sensing step A3. Thus, in each material sensing step A3, the controller C may obtain more information via the moving hanger 100 and calculate the clothing information.

FIG. 28 shows an additional example of a method for controlling a clothing treating apparatus of the present disclosure.

As described above, the clothing treating apparatus of the present disclosure may perform the sensing step A and the operating step S.

The operating step S may include the heating step S1 of operating the steam supply 50 to heat water accommodated in the steam generator 51, the steam step S2 of supplying steam to the accommodating space 21 when water boils in the steam generator 51 and steam is generated, the waiting step S3 of stopping the operation of the steam generator 51 when the steam is sprayed in a set amount or for a set time period, the cooling step S4 of cooling air in the accommodating space 21 while cooling the clothing by operating only the blower fan to improve the efficiency (COP) of the heat pump system, and the drying step S5 of supplying hot air to the accommodating space 21 by operating the compressor 83 and the blower fan.

The controller C may operate at least one of the steam generator and the moving hanger in the sensing step A to calculate the clothing information including at least one of the material of the clothing, the property including the hydrophilicity or the hydrophobicity, and the type of the clothing.

In some implementations, the amount of steam sprayed onto the clothing in the steam step S2 is also set differently based on the weight, the length, the material, the property, and the type of the clothing. This is because an optimized steam supply amount is determined based on the clothing information.

In some examples, the clothing treating apparatus of the present disclosure may perform the sensing step A before the steam step S2 or at the beginning of the steam step S2. In addition, the sensing step A may be performed from the heating step S1.

Because the heating step S1 is a state in which water is heated to become steam in the steam supply 50, it may be a step in which steam is not supplied to the accommodating space 21.

Therefore, the controller C may perform the weight sensing step A1 and the length sensing step A2 in the heating step S1.

When the steam step S2 starts, the controller C may perform the material sensing step A3. Specifically, the material sensing step A3 may be to perform the weight sensing step A1 and the length sensing step A2 after supplying steam to the clothing.

In the material sensing step A3, the controller C may operate the moving hanger 100 before operating the steam supply 50 or after operating the steam generator to calculate the clothing information.

Specifically, the controller C may sense the current value when operating the driver 200 before operating the steam supply 50 and the current value when operating the driver 200 after operating the steam supply 50, and then calculate the clothing information using the sensed current values.

In the sensing step A, because of the weight sensing step A1 and the length sensing step A2, the driver 200 may be operated in two or more speed ranges before the steam supply 50 operates. The controller C may operate the driver 200 in the speed range before the clothing starts to oscillate at the resonant frequency or in the standing wave and in the speed range equal to or higher than the speed at which the clothing starts to oscillate at the resonant frequency or in the standing wave.

In the sensing step A, because of the material sensing step A3, the controller C may operate the moving hanger 100 at two or more frequencies after operating the steam supply 50.

In the material sensing step A3, the controller C may operate the driver 200 in the speed range before the clothing starts to oscillate at the resonant frequency or in the standing wave and the speed range equal to or higher than the speed at which the clothing starts to oscillate at the resonant frequency or in the standing wave.

As a result, by performing the sensing step A, the controller C may operate the moving hanger before and after the steam supply 50 is operated.

The controller C may calculate the clothing information by sensing the change in the weight of the clothing, or may calculate the clothing information via a difference in the current values output from the driver 200.

In addition, the controller C may sense a change in the speed of the driver 200 that generates the resonant frequency or the standing wave in the clothing before and after the steam supply 50 is operated to calculate the clothing information. At this time, Equation (1) and Equation (2) above may be utilized.

The controller C may set the amount of steam supplied to the clothing in the steam step S2 based on the clothing information sensed in the sensing step A, when the material sensing step A3 is completed.

For example, the controller C may control the amount of steam generated from the steam supply 50 when the steam step S2 is performed to be greater when the clothing is sensed as hydrophilic or becomes closer to hydrophilic than when the clothing is hydrophobic. This allows the clothing to contain more moisture, thereby increasing the refreshing effect of the clothing.

In some cases, when the clothing is hydrophobic, the amount of steam may be reduced, thereby protecting the clothing and saving water and energy at the same time.

Furthermore, the controller C may set one or more of the operating speed of the driver 200 and the operating speeds of the compressor 83 and the blower fan after the waiting step S3 via the clothing information sensed in the sensing step A. For example, when the clothing is sensed as hydrophilic, the controller C may set the operating time or the operating rpm of the compressor to be greater in the drying step S5 than when the clothing is hydrophobic. This allows time for sufficient drying of the moisture contained in the clothing.

In some examples, when the clothing is hydrophobic, the clothing may be prevented from being over-dried by hot air and energy may be saved.

From another perspective, when the clothing is sensed as hydrophilic in the sensing step A, the duration of the operating step S may be set greater than when the clothing is sensed as hydrophobic. Because the hydrophilic clothing may contain more moisture, this is to sufficiently dry the hydrophilic clothing and then sufficiently shake off dust.

When the clothing is sensed as hydrophilic in the sensing step A, the operating time of the steam supply 50 may be set greater than that when the clothing is sensed as hydrophobic.

This is to supply more moisture to the hydrophilic clothing and increase the refreshing effect.

In addition, when the clothing is sensed as hard in the sensing step A, in the operating step S, the moving hanger 100 may be controlled such that the clothing oscillates faster than when the clothing is sensed as soft. This is to provide dust removing force to the clothing because the hard clothing has relatively less diffraction.

In addition, because the sensing step A is performed before the drying step S5 and before the steam step S2, it may be seen that at least one of the moving hanger 100 and the steam supply 50 is operated, but the operation of the compressor 83 is blocked in the sensing step A.

In the operating step S, because the moving hanger 100 is operated at the treating speed when the steam step S2 is ended, it may be seen that the moving hanger 100 operates after the steam supply 50 operates.

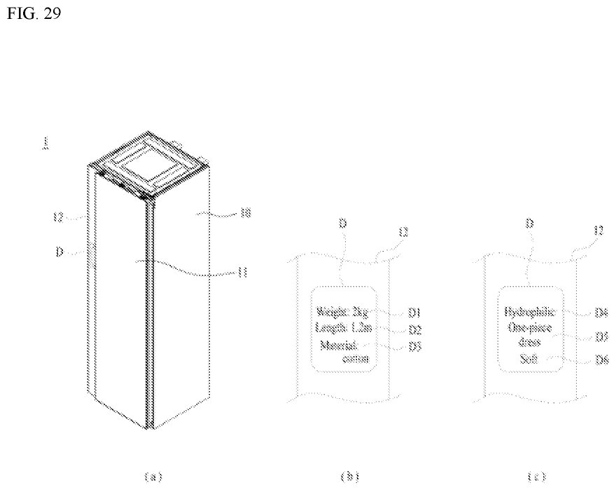

FIG. 29 shows a structure of confirming that a clothing treating apparatus of the present disclosure senses clothing information.

Referring to (a) in FIG. 29, the clothing treating apparatus of the present disclosure may be installed with the display D on the door 11.

In one example, the display D may be equipped on the cabinet 10. In some examples, where the door 11 forms the front surface of the cabinet 10, and the display D is installed on the door 11, the user may easily recognize the state of the display D.

The display D may externally display information received from the controller C as visual information and/or audio information, and may also externally display the clothing information sensed by the controller C.

The display D may display information of a course being performed by the controller C, and may be equipped as a screen such as a liquid crystal display.

In addition, at least a portion of the display D may be equipped as a touch panel or the like and may also perform a role of the input part I.

Referring to (b) in FIG. 29, the display D may display one or more of a weight D1 of the clothing, a length D2 of the clothing, and a material D3 of the clothing as one or more of numbers, letters, and pictograms.

Referring to (c) in FIG. 29, the display D may display information on the material or the property of the clothing in more detail. For example, the display D may display one or more of physical property information D4 regarding whether the clothing is hydrophilic/hydrophobic, a type D5 of the clothing, and linear density information D6 of the material, using one or more of numbers, letters, and pictograms.

The display D may display all of such clothing information D1 to D6, may display them selectively, or may display them alternately.

The display D may be controlled to, whenever the controller C senses specific clothing information, immediately display the specific clothing information, and may be controlled to display the clothing information when all of the clothing information that the controller C may sense are sensed.

For example, the controller C may sense the weight and the length of the clothing by operating the moving hanger 100 before the machine room 30 is operated.

Accordingly, the display D may display at least one of the weight and the length of the clothing before the machine room 30 is operated.

The controller C may sense the weight and the length of the clothing immediately by operating the moving hanger 100 when the power supply command is input via the input part I and the power is supplied or when the door 11 closes the accommodating space 21.

Therefore, the display D may display at least one of the weight and the length of the clothing when the power is input or the door 11 closes the opening.

The controller C may sense the weight and the length of the clothing by operating the moving hanger 100 before the steam generator 51 or the compressor 83 is operated.

Therefore, the display D may display at least one of the weight and the length of the clothing before the steam generator 51 or the compressor 83 is operated.

The controller C may sense at least one of the material, the property, and the type of the clothing by operating the moving hanger 100 and the steam supply 50 before the compressor is operated.

Therefore, the display D may display at least one of the material, the property, and the type of the clothing before the compressor is operated.

The controller C may perform the sensing step A when the power is input or the door 11 closes the opening.

Accordingly, the display D may display one or more of the material, the property, and the type of the clothing when the power is input or the door 11 closes the opening.

The controller C may receive the command to receive the power or the command to perform the course when the input part I is pressed, and as a result, may perform the sensing step A.

Therefore, the display D may display one or more of the weight and the length of the clothing, and the material, the property, and the type of the clothing after the input part I is pressed.

The present disclosure may be implemented by being modified in various forms, so that the scope of the rights thereof may not be limited to the above-described implementations. Therefore, when a modified implementation includes an element of the claims of the present disclosure, it should be considered to fall within the scope of the present disclosure.

1-29. (canceled)

30. A clothing treating apparatus comprising:
a cabinet;
an inner casing that is disposed in the cabinet and defines an accommodating space configured to receive clothing;
a door coupled to the cabinet and configured to open and close the accommodating space;
a machine room that is in fluid communication with the inner casing and configured to supply at least one of steam and hot air to the accommodating space;
a moving hanger disposed in the inner casing and configured to hang the clothing thereon, the moving hanger being configured to oscillate the clothing; and
a controller configured to operate at least one of the machine room or the moving hanger,
wherein the controller is configured to determine a weight of the clothing based on operating the moving hanger at a frequency lower than or equal to a fundamental frequency that causes the clothing to start to move in a waveform or vibrate.

31. The clothing treating apparatus of claim 30, wherein the controller is configured to determine the fundamental frequency based on operating the moving hanger.

32. The clothing treating apparatus of claim 30, wherein the controller is configured to:
determine the fundamental frequency based on operating the moving hanger by increasing an operating frequency from a stationary state; and
determine the weight of the clothing based on operating the moving hanger at the frequency lower than or equal to the fundamental frequency.

33. The clothing treating apparatus of claim 30, wherein the controller is configured to operate the moving hanger at a frequency higher than the fundamental frequency while supplying at least one of steam and hot air to the inner casing.

34. The clothing treating apparatus of claim 33, wherein the controller is configured to, based on the weight of the clothing, vary a maximum frequency to operating the moving hanger while supplying at least one of steam and hot air to the inner casing.

35. The clothing treating apparatus of claim 34, wherein the controller is configured to decrease the maximum frequency to operate the moving hanger based on an increase of the weight of the clothing.

36. The clothing treating apparatus of claim 30, wherein the controller is configured to operate the machine room to supply steam or hot air to the clothing after determining the weight of the clothing.

37. The clothing treating apparatus of claim 30, further comprising a display disposed at at least one of the cabinet or the door and configured to display the determined weight of the clothing.

38. The clothing treating apparatus of claim 37, wherein the display is configured to display the weight of the clothing before steam or hot air is supplied to the accommodating space.

39. A clothing treating apparatus comprising:
a cabinet;
an inner casing that is disposed in the cabinet and defines an accommodating space configured to receive clothing;
a machine room that is in fluid communication with the inner casing and configured to supply at least one of steam or hot air to the accommodating space;
a moving hanger disposed in the inner casing and configured to hang the clothing thereon, the moving hanger being configured to oscillate the clothing; and
a controller configured to operate at least one of the machine room or the moving hanger to perform a course for treating the clothing,
wherein the controller is configured to, based on operating the moving hanger, determine (i) a weight of the clothing and (ii) a resonant frequency that causes the clothing to vibrate in a standing wave.

40. The clothing treating apparatus of claim 39, wherein the controller is configured to:
determine the weight of the clothing based on operating the moving hanger at a first frequency lower than a fundamental frequency that causes the clothing to start to move in a waveform or vibrate; and
determine the resonant frequency based on operating the moving hanger at a second frequency higher than the first frequency.

41. The clothing treating apparatus of claim 40, wherein the controller is configured to, based on determining the weight of the clothing by operating the moving hanger at the first frequency, determine the resonant frequency by changing an operating frequency of the moving hanger.

42. The clothing treating apparatus of claim 40, wherein the controller is configured to, based on determining the weight of the clothing by operating the moving hanger at the first frequency, determine the resonant frequency by increasing an operating frequency of the moving hanger in a plurality of steps.

43. The clothing treating apparatus of claim 39, wherein the controller is configured to:
determine an optimal frequency for operating the moving hanger based on the determined weight of the clothing; and
operate the moving hanger at the resonant frequency close to the optimal frequency for at least a period during an execution of the course.

44. The clothing treating apparatus of claim 39, wherein the controller is configured to:
operate the moving hanger at the resonant frequency for at least a period during an execution of the course; and
operate the moving hanger at two or more resonant frequencies that cause the clothing to vibrate in standing waves during the execution of the course.

45. The clothing treating apparatus of claim 39, wherein the controller is configured to operate the moving hanger at the resonant frequency based on a magnitude of vibration of the moving hanger being greater than or equal to a reference value.

46. A method for controlling a clothing treating apparatus, the clothing treating apparatus including an inner casing that defines an accommodating space configured to receive clothing, a machine room including a steam generator configured to supply steam to the accommodating space and a compressor configured to pressurize a refrigerant for heat-exchange with air supplied to the accommodating space, and a moving hanger disposed in the inner casing and configured to hang the clothing thereon, the moving hanger being configured to oscillate the clothing, the method comprising:
determining a weight and a length of the clothing in the accommodating space based on operating the moving hanger while suppressing operation of the steam generator and the compressor; and
supplying steam and hot air to the clothing to treat the clothing.

47. The method of claim 46, wherein the moving hanger includes:
a power transmitter configured to support a load of the clothing; and
a driver configured to transmit power to reciprocally move the power transmitter,
wherein determining the weight and the length of the clothing comprises operating the driver at a first operating speed,
wherein the method further comprises operating the driver at a second operating speed while supplying steam and hot air to the clothing, and
wherein the first operating speed is lower than the second operating speed.

48. The method of claim 46, further comprising:
increasing a duration for supplying steam and hot air to the clothing based on an increase of the determined weight of the clothing.

49. The method of claim 46, wherein determining the weight and the length of the clothing is performed before steam is supplied to the inner casing.
